(19) United States
(12) Patent Application Publication
(10) Pub. No.: US 2024/0021875 A1
(43) Pub. Date: Jan. 18, 2024

(54) METAL ION COORDINATED CHITOSAN ELECTROLYTE FOR ION TRANSPORT, ITS STRUCTURE AND FABRICATION METHOD

(71) Applicant: University of Maryland, College Park, College Park, MD (US)

(72) Inventors: Liangbing HU, Rockville, MD (US); Meiling WU, Berwyn Heights, MD (US)

(21) Appl. No.: 18/347,114

(22) Filed: Jul. 5, 2023

Related U.S. Application Data
(60) Provisional application No. 63/367,706, filed on Jul. 5, 2022.

(51) Int. Cl. H01M 10/0565; H01M 10/054

(52) U.S. Cl. CPC H01M 10/0565; H01M 10/054; H01M 2300/0082

(57) ABSTRACT

The disclosure provides an electrolyte comprising a plurality of chitosan molecular chains crosslinked with zinc cations. The disclosure also provides an electrochemical device comprising: an anode; a cathode; and an electrolyte positioned between the anode and the cathode, wherein the electrolyte comprises a plurality of chitosan molecular chains crosslinked with zinc cations. In one embodiment, the device is a zinc ion battery, and the cathode comprises a zinc host material selected from the group consisting of (i) metal oxides, metal sulfides, metal phosphates, and metal selenides wherein the metal is one or more of manganese, vanadium, zinc, lithium, cobalt, iron, molybdenum, titanium, niobium, bismuth and tungsten, (ii) poly(benzoquinonyl sulfide), (iii) lead titanate, (iv) Prussian blue compounds, (v) electrically conductive polymers, and (vi) mixtures thereof, and the anode comprises a material selected from metallic zinc and zinc alloys.

### CROSS-REFERENCES TO RELATED APPLICATION(S)

This application claims priority to U.S. Patent Application No. 63/367,706 filed Jul. 5, 2022, which hereby is incorporated by reference in its entirety.

### STATEMENT REGARDING FEDERALLY SPONSORED RESEARCH

Not applicable.

### BACKGROUND

### 1. Field

This disclosure relates to electrolytes that can facilitate transport of ions with wide applications in electrochemical devices, such as batteries.

### 2. Description of the Related Art

To reduce carbon emissions and realize carbon neutrality, it is essential to develop sustainable rechargeable batteries for the storage of renewable energy [Ref.1,2]. Aqueous rechargeable batteries, such as Zn-metal batteries, which use a Zn-metal anode and water-based electrolytes, are attractive candidates to fulfill these energy storage demands due to their inherent safety, fast charging/discharging capability, environmental friendliness, wide material availability, and low cost [Ref. 3,4]. Conventional zinc metal batteries comprise an anode including zinc metal, a cathode including a zinc host material, a separator material that keeps the anode and the cathode from touching but allows Zn²⁺ ions through, and a liquid electrolyte (e.g., an aqueous or non-aqueous electrolyte including zinc salts). During a typical discharge process, zinc ions from the anode are extracted into the electrolyte, and zinc ions in the electrolyte are intercalated into the cathode material. This movement of the ions from anode to cathode is accompanied by the release of electrons which flow in the external circuit. The reverse process occurs during the charging process where zinc ions move from the cathode to the anode through the electrolyte.

However, rechargeable Zn-metal batteries have yet to be commercialized, largely because of problems associated with the Zn-metal anode, including undesired Zn dendrite formation, corrosion, and hydrogen generation during the Zn plating/stripping process [Ref. 5,6], all of which can cause low cycling reversibility and ultimately battery failure. These issues mainly stem from the unregulated Zn-deposition morphology at high current densities as well as the high free-water content in conventional aqueous electrolytes, which reacts with the Zn-metal during electrochemical cycling [Ref. 7-10]. The aqueous electrolyte induces surface passivated reactions on the Zn surface, which leads to inhomogeneous Zn deposition that causes possible dendrite penetration through the separator and low cycling reversibility [Ref. 11-13]. To address these challenges, extensive efforts have been devoted to modifying the electrolyte, including the use of high-salt-concentration “water-in-salt” electrolytes [Ref. 14-16], various additives to aqueous electrolytes (such as ethylene glycol as a water blocker) [Ref. 17,18], or organic electrolytes [Ref. 19,20]. However, these strategies sacrifice the intrinsic high conductivity of aqueous electrolytes and/or compromise the safety of the Zn-metal battery [Ref. 21]. There are reports of hydrogel electrolytes that show promise at inhibiting Zn dendrites, as the nanochannels and polar groups of the hydrogel can control the free-water content and enhance the uniformity of the current distribution [Ref. 9,22-24]. However, current hydrogel electrolytes do not meet the high mechanical strength, high rate capability, and long-term cycling stability needed for high-performance Zn-metal batteries [Ref. 1, 25].

What is needed therefore are improved electrolytes that meet the high mechanical strength, high rate capability, and long-term cycling stability needed for high-performance Zn-metal batteries.

### SUMMARY

The present disclosure addresses the foregoing needs by providing a chitosan material that can act as an electrolyte in an electrochemical device.

In one aspect, the disclosure provides an electrolyte comprising a plurality of chitosan molecular chains crosslinked with zinc cations. In one embodiment, the electrolyte has a zinc ion conductivity of greater than 30 mS cm⁻¹ at room temperature. In one embodiment, the electrolyte has a zinc ion conductivity is greater than 70 mS cm⁻¹ at room temperature. In one embodiment, the electrolyte has a water content of 20 wt. % to 75 wt. % based on a total weight of the electrolyte. In one embodiment, the electrolyte has pores below micrometer scale. In one embodiment, the electrolyte has nanopores. In one embodiment, the electrolyte has no pores above micrometer scale. In one embodiment, the electrolyte has a BET surface area of at least 16 m² g⁻¹. In one embodiment, the electrolyte has a tensile strength of at least 2 MPa. In one embodiment, the electrolyte has a tensile strength of at least 5 MPa. In one embodiment, the zinc cations are coordinated with amino groups and hydroxyl groups of the chitosan molecular chains. In one embodiment, the electrolyte has a thickness in a range of 1 to 1000 micrometers. In one embodiment, the plurality of chitosan molecular chains are crosslinked by contacting the plurality of chitosan molecular chains with the zinc cations in an alkaline environment. In one embodiment, the plurality of chitosan molecular chains are crosslinked by contacting the plurality of chitosan molecular chains with the zinc cations in a hydroxide solution.

In another aspect, the disclosure provides an electrochemical device comprising: an anode; a cathode; and an electrolyte positioned between the anode and the cathode, wherein the electrolyte comprises a plurality of chitosan molecular chains crosslinked with zinc cations. In one embodiment, the device is a zinc ion battery, and the cathode comprises a zinc host material selected from the group consisting of (i) metal oxides, metal sulfides, metal phosphates, and metal selenides wherein the metal is one or more of manganese, vanadium, zinc, lithium, cobalt, iron, molybdenum, titanium, niobium, bismuth and tungsten, (ii) poly(benzoquinonyl sulfide), (iii) lead titanate, (iv) Prussian blue compounds, (v) electrically conductive polymers, and (vi) mixtures thereof. In one embodiment, the cathode comprises poly(benzoquinonyl sulfide). In one embodiment, the anode comprises a material selected from metallic zinc and zinc alloys. In one embodiment, the zinc ion battery includes a zinc-deposition morphology of zinc platelets on the anode. In one embodiment, the zinc ion battery includes a zinc-deposition morphology of hexagonal zinc platelets with an orientation parallel to a surface of the anode. In one embodiment, the platelets have a size greater than 500 nanometers. In one embodiment, the zinc ion battery has an areal capacity greater than 2 mAh cm⁻² at a current density of 5 mA cm⁻². In one embodiment, the zinc ion battery has a Coulombic efficiency greater than 98% over 400 cycles at a C-rate of 2C. In one embodiment, the zinc ion battery has a capacity retention of greater than 60% over 400 cycles at a C-rate of 2C. In one embodiment, the device is a zinc air battery, and the cathode comprises porous carbon.

In still another aspect, the disclosure provides an electrode comprising: a zinc host material; and an electrolyte comprising a plurality of chitosan molecular chains crosslinked with zinc cations. In one embodiment, the electrode includes 2 wt. % to 20 wt. % of the electrolyte based on a total weight of the electrode. In one embodiment, the zinc host material is selected from the group consisting of (i) metal oxides, metal sulfides, metal phosphates, and metal selenides wherein the metal is one or more of manganese, vanadium, zinc, lithium, cobalt, iron, molybdenum, titanium, niobium, bismuth and tungsten, (ii) poly(benzoquinonyl sulfide), (iii) lead titanate, (iv) Prussian blue compounds, (v) electrically conductive polymers, and (vi) mixtures thereof. In one embodiment, the electrolyte has a zinc ion conductivity of greater than 70 mS cm⁻¹ at room temperature. In one embodiment, the electrolyte has nanopores. In one embodiment, the electrolyte has a BET surface area of at least 16 m² g⁻¹. In one embodiment, the electrolyte has a tensile strength of at least 5 MPa. In one embodiment, the zinc cations are coordinated with amino groups and hydroxyl groups of the chitosan molecular chains.

In yet another aspect, the disclosure provides a method for forming an electrolyte. The method can comprise: (a) casting a flowable composition including chitosan on a support to form a chitosan membrane on the support; (b) contacting the chitosan membrane with a solution including zinc cations to form a chitosan-Zn membrane; and (c) separating the chitosan-Zn membrane from the support to form an electrolyte comprising a plurality of chitosan molecular chains crosslinked with zinc cations. In one embodiment of the method, step (b) further comprises applying a pressure to the chitosan-Zn membrane after contacting the chitosan membrane with the solution, the pressure being above atmospheric pressure. In one embodiment of the method, step (b) comprises immersing the chitosan membrane on the support in a bath containing the solution, wherein the solution is an alkaline solution. In one embodiment of the method, the solution is a hydroxide solution. In one embodiment of the method, the solution is a Zn²⁺-saturated hydroxide solution. In one embodiment of the method, the solution is a Zn²⁺-saturated NaOH solution. In one embodiment of the method, step (a) comprises transporting the support from a roll of the support to a zone where the flowable composition including chitosan is cast on the support. In one embodiment of the method, step (c) comprises collecting the electrolyte on a roll after separating the electrolyte from the support. In one embodiment of the method, step (b) comprises applying a pressure of 1 MPa or greater. In one embodiment of the method, step (b) comprises applying a pressure in a range of 1 MPa to 10 MPa. In one embodiment of the method, step (b) comprises applying the pressure such that the electrolyte has pores below micrometer scale. In one embodiment of the method, step (b) comprises applying the pressure such that the electrolyte has no pores above micrometer scale. In one embodiment of the method, step (b) comprises applying the pressure such that the electrolyte has a BET surface area of at least 16 m² g⁻¹. In one embodiment of the method, step (b) comprises applying the pressure such that the electrolyte has a tensile strength of at least 2 MPa. In one embodiment of the method, the flowable composition includes 1 wt. % to 10 wt. % chitosan based on a total weight of the flowable composition. In one embodiment of the method, step (b) further comprises washing the chitosan-Zn membrane with water.

A Zn-metal battery is a promising clean energy-storage device, but its application is hindered by uncontrolled Zn deposition in the Zn-metal anode. We have found that a biomaterial-derived chitosan-Zn electrolyte enables favorable Zn-platelet deposition due to its high mechanical strength, high Zn²⁺ conductivity, and water bonding capability. The chitosan-Zn electrolyte not only enables high-rate and long-life performance but is also biodegradable, appealing for clean and efficient energy storage.

These and other features, aspects, and advantages of examples provided in the present disclosure will become better understood upon consideration of the following detailed description, drawings, and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a non-limiting example of a battery in which an electrolyte of the present disclosure can be used.

FIG. 1A shows chitosan-Zn electrolyte and the corresponding Zn plating morphologies in Zn-metal batteries. Panel (A): Schematic comparison of the porous chitosan-Zn with flooded aqueous electrolyte and densified chitosan-Zn electrolyte. The chitosan polymer chains are coordinated with Zn²⁺ to form the porous chitosan-Zn membrane (left). The porous chitosan-Zn is then compressed to make the dense chitosan-Zn electrolyte (right). Panels (B and C): Scanning electron microscopy (SEM) images of electrochemically deposited Zn-metal anodes that were cycled using Panel (B) the porous chitosan-Zn electrolyte, which results in randomly deposited Zn dendrites, and Panel (C) the dense chitosan-Zn electrolyte, which enables the deposition of parallel-stacked Zn plates.

FIG. 2 shows morphology and characterization of the chitosan-Zn membranes. Panel (A): Photo of the porous chitosan-Zn membrane. Panels (B and C): SEM images of the Panel (B) surface and Panel (C) cross-sectional morphology of the porous chitosan-Zn membrane. Panel (D): Photo of the chitosan-Zn membrane after pressing. Panels (E and F): SEM images of the Panel (E) surface and Panel (F) cross-sectional morphology of the chitosan-Zn membrane after pressing. Panel (G): The N₂ isotherm adsorption/desorption curves of the chitosan-Zn, porous chitosan-Zn, and chitosan membranes. Panel (H): Comparison of the ultimate tensile stress of the chitosan-Zn membrane with other reported membranes [Ref. 23,29-33]. Panel (I): DSC curves of chitosan-Zn membranes with different percentages of water content. Pure water, noted as 100%, was tested as a reference.

FIG. 3 shows Zn plating behavior. Panel (A): The conductivity of the chitosan-Zn electrolytes with different water contents (15%-72%). Panel (B): The conductivity of the aqueous electrolyte (2 M ZnSO₄, featuring 76% water content and using a glass-fiber separator). Panels (C-F): Morphology of the Zn plating on the Zn anode after cycling at 20 mA cm² and 4 mAh cm² for 50 cycles in Zn∥Zn cells with different chitosan-Zn electrolytes containing water contents of Panel (C) 34%, Panel (D) 57%, and Panel (E) 72%, as well as using the Panel (F) 2 M ZnSO₄ aqueous electrolyte with a glass-fiber separator. Panels (G and H): Schematic diagrams of Zn plating on the Zn anode using different electrolytes, including Panel (G) chitosan-Zn and Panel (H) aqueous electrolyte. Panel (I): The Coulombic efficiency of Zn∥Cu cells using different chitosan-Zn electrolytes with varied water contents, as well as 2M ZnSO₄ aqueous electrolyte, at 5 mA cm⁻² and 5 mAh cm⁻².

FIG. 4 shows electrochemical performance of Zn plating/stripping using chitosan-Zn and aqueous electrolytes. Panels (A and B): The Zn plating/stripping Coulombic efficiency on a Cu electrode cycled with chitosan-Zn and aqueous electrolytes at 10 mA cm⁻² and 2 mAh cm⁻² Panel (A) and the corresponding Zn plating/stripping voltage profiles on a Cu electrode cycled with chitosan-Zn electrolyte Panel (B). Panel (C): Galvanostatic Zn plating/stripping in a Zn∥Zn symmetric cell cycled with chitosan-Zn and aqueous electrolytes at 50 mA cm⁻² and 10 mAh cm⁻². Panel (D): Performance comparison of the Zn∥Zn symmetric cell in terms of the current density and cumulative capacity cycled using the chitosan-Zn electrolyte and other reported electrolytes [Ref. 15-18, 51-58]. Panel (E): Galvanostatic charge-discharge potential profiles of the Zn∥PBQS cell using chitosan-Zn electrolyte and aqueous electrolyte at 5C rates. The PBQS loading was 10 mg cm⁻². Panel (F): Rate performance comparison of the Zn∥PBQS battery using the chitosan-Zn and aqueous electrolyte with a rate ranging from 1 to 20C. Panel (G): Cycling performance of the Zn∥PBQS cell using the chitosan-Zn electrolyte at 2C with a PBQS loading of 10 mg cm⁻².

FIG. 5 shows safety, biodegradability, and sustainability of chitosan-Zn electrolyte Panels (A-C). Photos of Panel (A) the chitosan-Zn electrolyte prior to flame exposure, Panel (B) the chitosan-Zn electrolyte held in the flame, and Panel (C) the chitosan-Zn electrolyte after burning. Panel (D-F) Photos of Panel (D) fresh chitosan-Zn electrolyte, and chitosan-Zn electrolyte buried in soil for Panel (E) 2 and Panel (F) 5 months. Panel (G): A schematic diagram of the sustainable Zn-metal battery based on the chitosan biomaterial, which comes from the shrimps and crabs and degrades in soil after use.

FIG. 6 shows: (i) in the top panels that a biomaterial-derived chitosan-Zn electrolyte enables favorable Zn-platelet deposition due to its high mechanical strength, high Zn²⁺ conductivity, and water bonding capability; and (ii) in the bottom panel, FIG. 4, Panel (D).

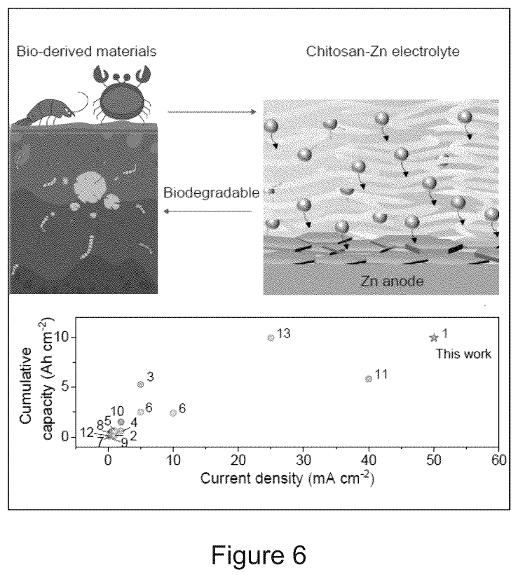

FIG. 7 shows fabrication and characterizations of the chitosan-Zn membrane. Panel (A) is a schematic diagram of the preparation of the chitosan-Zn membrane. Chitosan solution is first cast on a PET support (left), then immediately immersed in a Zn²⁺-saturated NaOH solution (middle). The resulting porous chitosan-Zn membrane is rinsed with water and mechanically pressed to obtain the final densified chitosan-Zn membrane (right). Panel (B) is a cross-sectional SEM image revealing the densified structure. Panel (C) is an EDS elemental mapping of C, O, N and Zn in the densified chitosan-Zn membrane that indicates the elements are uniformly distributed.

FIG. 8 shows the morphology of the porous and densified chitosan membranes. Panel (A): The surface and Panel (B): cross-sectional morphology of the porous chitosan membrane. Panel (C): The surface and Panel (D): cross-sectional morphology of the chitosan membrane after pressing. The porous chitosan membrane displays a hierarchical porous structure, which is similar to the porous chitosan-Zn membrane. After densification, the pores are eliminated, resulting in a dense structure.

FIG. 9 shows XPS and FTIR analysis of the densified chitosan-Zn and chitosan membranes. Panel (A): The Zn 2p XPS spectrum of the chitosan-Zn membrane. Panel (B): The XPS N1s spectra of the chitosan-Zn and chitosan membranes. Panel (C): The FTIR spectra of the chitosan-Zn and chitosan membranes.

FIG. 10 shows a comparison of BET surface area. The BET surface area of the densified chitosan, densified chitosan-Zn, and porous chitosan-Zn membranes.

FIG. 11 shows a mechanical strength comparison. The tensile stress-strain curves of the wet densified chitosan-Zn (mimicking the battery conditions), wet porous chitosan-Zn, densified chitosan, and a glass fiber membrane. The densified chitosan-Zn membrane shows a much higher strength than the glass fiber separator that is commonly used in Zn-metal batteries. In addition, the higher tensile stress of the chitosan-Zn membrane (7.36 MPa) compared to the porous chitosan-Zn (0.67 MPa) and chitosan membranes (0.25 MPa) indicates that both Zn²⁺ coordination and the densification process increases the material's mechanical strength.

FIG. 12 shows snapshot photos of 2 M ZnSO₄ aqueous solution wetting ability on densified chitosan-Zn electrolyte: Panel (A): 0 s; Panel (B): 1.4 s; and Panel (C): 3.4 s. The pristine chitosan-Zn membrane is semitransparent (Panel A). After adding a drop of ZnSO₄ aqueous solution on it, the aqueous solution spreads to the whole surface of the chitosan-Zn membrane quickly (Panel B), indicating a strong hydrophilic property. After 2 s, a transparent color in chitosan-Zn membrane was observed (Panel C), suggesting the aqueous solution penetrates the chitosan-Zn membrane, which also demonstrates that the aqueous solution has an excellent wetting ability to the chitosan-Zn membrane.

FIG. 13 shows EIS of the chitosan-Zn electrolytes and pure aqueous electrolyte. EIS curves of the chitosan-Zn electrolytes with different water contents, including Panel (A): 15% and Panel (B): 43-72%, as well as the Panel (C): 2 M ZnSO₄ aqueous electrolyte (76% water content). Zn∥Zn cells are applied to measure the conductivity of the chitosan-Zn/ZnSO₄ electrolyte. The intercept at the x-axis (high frequency region) indicates the resistance of the electrolyte, which was used to calculate the ionic conductivities of the different samples.

FIG. 14 shows a comparison of Zn²⁺ conductivity. Panel (A): EIS curve of the densified chitosan-Zn membrane. The chitosan-Zn membrane is fabricated with a similar process with that of chitosan-Zn electrolyte, except that the 2 M ZnSO₄ immersing process is not applied. Panel (B): a comparison of Zn²⁺ conductivity between densified chitosan-Zn electrolyte and chitosan-Zn membrane without ZnSO₄.

FIG. 15 shows Zn plating morphology. Panel (A): The surface morphology of the pristine Zn metal, used as the electrodes in the Zn∥Zn cells. Panels (B-F): The surface morphology of the Zn anode in Zn∥Zn cells after plating at 20 mA cm⁻² and 4 mAh cm⁻² for 50 cycles using chitosan-Zn electrolytes with different water contents of Panel (B) 43%, Panels (C, D) 57%, Panel (E) 66%, and Panel (F) 72%. When applying chitosan-Zn electrolytes with water contents of 43% and 57%, the electrochemically deposited Zn displays hexagonal platelets stacked parallel on the Zn electrode surface, which is beneficial for reducing the interfacial area between the Zn anode and electrolyte, and thus the interfacial resistance. With increased water content (e.g., 66% and 72%), the plated Zn is moss-like in morphology, with a large surface area and the potential to form dead Zn and even short circuits induced by dendritic penetration through the electrolyte.

FIG. 16 shows voltage profiles of the galvanostatic Zn plating/stripping of the chitosan-Zn electrolytes. (a) The voltage profiles of Zn∥Zn cells cycled at 20 mA cm⁻² and 4 mAh cm⁻² using chitosan-Zn electrolytes with 34% and 57% water contents. The cell using chitosan-Zn electrolyte with 34% water content shows a higher plating overpotential than that of 57% water content.

FIG. 17 shows TEM measurements of the Zn plating morphology. Panel (A): TEM image of Zn platelets with hexagonal shape formed on the anode of Zn∥Zn cells using chitosan-Zn electrolyte with 57% water content. Panel (B): Magnified TEM image of a Zn platelet. Panel (C): A high resolution TEM image of a Zn platelet and schematic diagram of the Zn unit cell in the inset. The lattice distance (0.23 nm) is consistent with the distance between (−1010) planes. In addition, the angle between the (−1100) and (−1010) plane is 120°. Panel (D) is a schematic diagram of the Zn platelets composed of small polycrystalline Zn platelets. The Zn platelets in a-c were obtained after plating at 20 mA cm⁻² and 4 mAh cm⁻² for 50 cycles.

FIG. 18 shows Zn plating morphology. The Zn anode surface morphology in Zn∥Zn cells using chitosan-Zn electrolyte with 57% water content after plating at 10 mA cm⁻² and 2 mAh cm⁻² for 20 cycles: Panel (A): Low magnification; Panel (B): High magnification. Small Zn platelets with a size of ˜200 nm begin to appear, demonstrating a hexagonal shape.

FIG. 19 shows morphology of the aqueous electrolyte with glass fiber and chitosan-Zn electrolyte after Zn plating/stripping. The electrolyte surface morphology in Zn∥Zn cells after plating at 10 mA cm⁻² and 2 mAh cm⁻² for 50 cycles using different electrolytes: Panel (A): the aqueous electrolyte with a glass fiber as a separator; and Panel (B): chitosan-Zn electrolyte with 57% water content. To observe the morphology of both electrolytes by SEM, both samples are freeze-dried to remove the water inside the membranes. The fibers, platelets, and particle aggregation in Panel (A) are ascribed to the glass fibers, randomly orientated Zn platelets, and ZnSO₄, respectively. The randomly orientated Zn platelets are able to penetrate the glass fiber separator, reducing the cell lifetime. Meanwhile, the chitosan-Zn electrolyte maintains a dense, uniform surface.

FIG. 20 shows Coulombic efficiency of the Zn∥Cu cell using the Panels (A and B) chitosan-Zn electrolyte and Panel (C) porous chitosan-Zn electrolyte (i.e., without densifying). The Zn plating/striping Coulombic efficiency on a Cu electrode cycled with chitosan-Zn electrolyte at Panel (A) 5 mA cm⁻² and 1 mAh cm⁻²; and Panel (B) 5 mA cm⁻² and 5 mAh cm⁻². Panel (C): The Zn plating/striping Coulombic efficiency on a Cu electrode cycled with the porous chitosan-Zn electrolyte at 10 mA cm⁻² and 2 mAh cm⁻².

FIG. 21 shows the Zn plating/striping voltage profiles of the Zn∥Cu cell using aqueous electrolyte. Zn plating/striping on a Cu electrode cycled with aqueous electrolyte at 10 mA cm⁻² and 2 mAh cm⁻².

FIG. 22 shows galvanostatic Zn plating/striping. Galvanostatic Zn plating/stripping in a Zn∥Zn cell using chitosan-Zn electrolyte and aqueous electrolyte at Panel (A): 5 mA cm⁻² and 1 mAh cm⁻², and Panel (B): 5 mA cm⁻² and 2.5 mAh cm⁻².

FIG. 23 shows galvanostatic Zn plating/striping. Galvanostatic Zn plating/striping in a Zn∥Zn symmetric cell using the Panel (A): porous chitosan-Zn electrolyte and aqueous electrolyte, Panel (B): chitosan-Zn electrolyte without densifying, and Panel (C): densified chitosan electrolyte (without Zn²⁺ coordination) at 10 mA cm⁻² and 2 mAh cm⁻².

FIG. 24 shows EIS spectra of the Zn∥Zn symmetric cell: Pristine Zn∥Zn cell (Black dots) and Zn∥Zn cell after cycling at 10 mA cm⁻² and 2 mAh cm⁻² for 1000 cycles (Red dots).

FIG. 25 shows Zn anode surface morphology after galvanostatic Zn plating/stripping: Panel (A) Low magnification; Panel (B) High magnification. The Zn anode surface morphology in Zn∥Zn cells after plating at 10 mA cm⁻² and 2 mAh cm⁻² for 1000 cycles using the chitosan-Zn electrolyte. The hexagonal Zn platelets are maintained.

FIG. 26 shows XRD measurements of the Zn anode. XRD patterns of pristine Zn and the Zn anode in Zn∥Zn cells after plating/stripping at 10 mA cm⁻² and 2 mAh cm⁻² for 400 cycles using chitosan-Zn and aqueous electrolytes. There are obvious peaks (indicated by green squares) in the XRD curve of the Zn anode using the aqueous electrolyte, which are ascribed to the side product of Zn₄SO₄(OH)₆·xH₂O [Ref. S1]. This product is present but less detectable in the XRD curve of the Zn anode using the chitosan-Zn electrolyte, suggesting chitosan-Zn electrolyte can suppress the production of side product efficiently. The peaks indicated by the purple dots are ascribed to plating Zn and substrate Zn.

FIG. 27 shows a comparison of swelling in coin cells after Zn plating using the chitosan-Zn and aqueous electrolytes. Digital photos of Zn∥Zn coin cells after plating at 50 mA cm⁻² and 10 mAh cm⁻² for 100 cycles using Panel (A) chitosan-Zn and Panel (B) aqueous electrolytes. The coin cell using the aqueous electrolyte swells to rupture due to the cumulative H₂ gas evolved from H₂ evolution reaction from the excess water in the aqueous electrolyte during the Zn plating process. Meanwhile, the coin cell using the chitosan-Zn electrolyte remained intact and no obvious swelling was observed, indicating the ability of the chitosan-Zn electrolyte to suppress the H₂ evolution due to limited free water in chitosan-Zn electrolyte.

FIG. 28 shows the performance of the Zn-metal full cell. Galvanostatic charge-discharge potential profiles of the Zn∥PBQS cell at different rates using Panel (A): chitosan-Zn electrolyte and Panel (B): aqueous electrolyte. Panel (C): The cycling performance of the Zn∥PBQS cell in 2 M ZnSO₄ at 2C with a PBQS loading of 10 mg cm⁻². Panel (D): Performance comparison of Zn-metal batteries with different electrolytes [Ref. S2-S12] in terms of the current density and areal capacity.

### DETAILED DESCRIPTION

Before any embodiments of this disclosure are explained in detail, it is to be understood that the present disclosure is not limited in its application to the details of construction and the arrangement of components set forth in the following description or illustrated in the following drawings. The presented examples are capable of other embodiments and of being practiced or of being carried out in various ways.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. As used herein, the term “C-rate” can be understood as follows. Charge and discharge rates of a battery are governed by C-rates. The capacity of a battery is commonly rated at 1C, meaning that a fully charged battery rated at 1 Ah should provide 1 amp (A) for one hour. The same battery discharging at 0.5C should provide 0.5 A for two hours, and at 2C, it delivers 2 A for 30 minutes. As illustrative examples, a C-rate of 1C is also known as a one-hour charge or discharge; a C-rate of 4C is a ¼-hour charge or discharge; a C-rate of 2C is a ½-hour charge or discharge; a C-rate of 0.5C or C/2 is a 2-hour charge or discharge; a C-rate of 0.2C or C/5 is a 5-hour charge or discharge, and a C-rate of 0.1C or C/10 is a 10-hour charge or discharge.

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown and described but are to be accorded the widest scope consistent with the principles and features disclosed herein. Skilled artisans will recognize the examples provided herein have many useful alternatives and fall within the scope of embodiments of the disclosure.

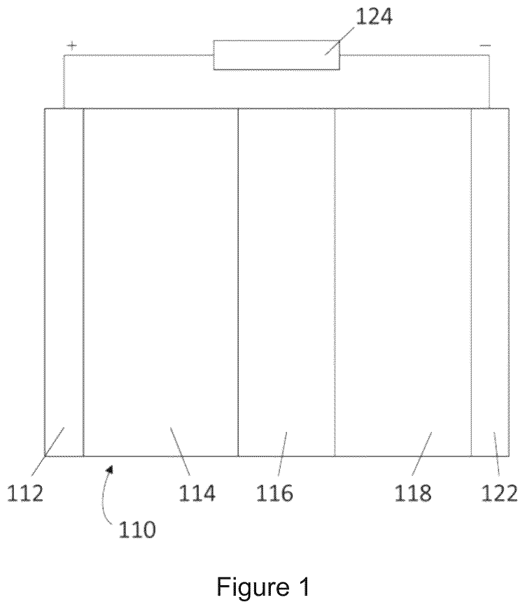

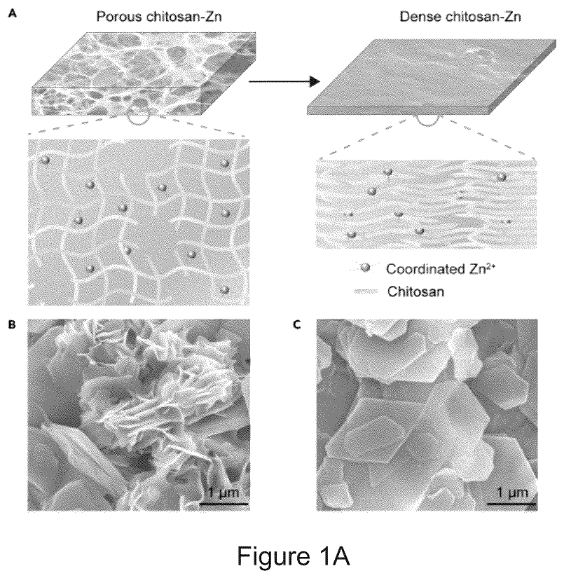

The electrolytes of the present disclosure can be used in a battery such as the non-limiting example zinc ion battery 110 as shown in FIG. 1. The zinc ion battery 110 includes a current collector 112 in contact with a cathode 114. An electrolyte 116 is arranged between the cathode 114 and an anode 118, which is in contact with a current collector 122. The current collectors 112 and 122 of the zinc ion battery 110 may be in electrical communication with an electrical component 124. The electrical component 124 can place the zinc ion battery 110 in electrical communication with an electrical load that discharges the battery or a charger that charges the lithium-ion battery. During a typical discharge process, zinc ions from the anode 118 are transported through the electrolyte 116, and zinc ions that have transported through the electrolyte 116 are intercalated into the material of the cathode 114. This movement of the ions from the anode 118 to the cathode 114 is accompanied by the release of electrons which flow in the external circuit including the electrical component 124. The reverse process occurs during the charging process where zinc ions deintercalate from the cathode 114 and are transported through the electrolyte 116 to the anode 118.

The first current collector 112 and the second current collector 122 can comprise a conductive metal or any suitable conductive material. In some embodiments, the first current collector 112 and the second current collector 122 comprise zinc, aluminum, nickel, copper, combinations and alloys thereof. It is to be appreciated that the thicknesses depicted in FIG. 1 are not drawn to scale, and that the thickness of the first current collector 112 and the second current collector 122 may be different.

A suitable active material for the cathode 114 of the zinc ion battery 110 is a zinc host material capable of storing and subsequently releasing zinc ions. The cathode 114 can comprise a zinc host material selected from the group consisting of (i) metal oxides, metal sulfides, metal phosphates, and metal selenides wherein the metal is one or more of manganese, vanadium, zinc, lithium, cobalt, iron, molybdenum, titanium, niobium, bismuth and tungsten, (ii) poly(benzoquinonyl sulfide), (iii) lead titanate, (iv) Prussian blue compounds, (v) electrically conductive polymers (such as polyaniline, polyacetylene, polypyrene, and polyorganosulfides), and (vi) mixtures thereof. The cathode 114 can optionally further comprise an electrolyte according to any embodiments of the present disclosure wherein the electrolyte is present in the cathode at a weight percentage in a range of 2 wt. % to 20 wt. % based on a total weight of the cathode. In other embodiments, the cathode 114 of the zinc ion battery 110 can comprise porous carbon (for a zinc air battery). The cathode 114 can optionally further comprise a conductive filler such as Ketjen black, acetylene black, nanoporous carbon, graphite, furnace black, channel black, and mixtures thereof. The cathode 114 can optionally further comprise a binder such as a polyimide, an acrylate, ethyl cellulose, polyvinylidene fluoride, polytetrafluoroethylene, a polyolefin, ethylene-propylene-diene terpolymer, an alkyl vinyl ether, a fluororubber, and mixtures thereof.

In some embodiments, a suitable active material for the anode 118 of the zinc ion battery 110 comprises a material selected from metallic zinc and zinc alloys. In one embodiment, the anode 118 of the zinc ion battery 110 consists essentially of metallic zinc or a zinc alloy. Non-limiting examples of zinc alloys that may be used in the anode include alloys of zinc with one or more of lead, vanadium, chromium, manganese, iron, cobalt, nickel, cadmium, tungsten, bismuth, tin, indium, antimony, copper, and titanium.

The electrolyte for the battery 110 may be an electrolyte according to any embodiments of the present disclosure. An electrolyte of the present disclosure comprises a plurality of chitosan molecular chains crosslinked with zinc cations. Chitosan is a natural material that includes a plurality of molecular chains of polysaccharides, more specifically, the molecular chains are a random distributed units of β-(1→4)-linked D-glucosamine (deacetylated unit) and units of N-acetyl-D-glucosamine. According to an aspect of the disclosure herein, the plurality of chitosan molecular chains can be crosslinked with zinc cations, such as Zn²⁺, to form an electrolyte. The zinc cations coordinate between the chains along at least a portion of the chitosan molecular chains. The zinc cations can be coordinated with amino groups and/or hydroxyl groups of the chitosan molecular chains. The plurality of chitosan molecular chains can be crosslinked by contacting the plurality of chitosan molecular chains with the zinc cations in an alkaline environment. The plurality of chitosan molecular chains can be crosslinked by contacting the plurality of chitosan molecular chains with the zinc cations in a hydroxide solution.

In certain embodiments, the electrolyte has a zinc ion conductivity of greater than 30 mS cm⁻¹ at room temperature, or a zinc ion conductivity of greater than 40 mS cm⁻¹ at room temperature, or a zinc ion conductivity of greater than 50 mS cm⁻¹ at room temperature, or a zinc ion conductivity of greater than 60 mS cm⁻¹ at room temperature, or a zinc ion conductivity of greater than 70 mS cm⁻¹ at room temperature.

In certain embodiments, the electrolyte has a water content of 20 wt. % to 75 wt. % based on a total weight of the electrolyte, or a water content of 30 wt. % to 70 wt. % based on a total weight of the electrolyte, or a water content of 40 wt. % to 70 wt. % based on a total weight of the electrolyte, or a water content of 50 wt. % to 70 wt. % based on a total weight of the electrolyte.

In certain embodiments, the electrolyte has pores below micrometer scale. In certain embodiments, the electrolyte has nanopores. In certain embodiments, the electrolyte has no pores above micrometer scale. In certain embodiments, the electrolyte has a BET surface area of at least 16 m² g⁻¹.

In certain embodiments, the electrolyte has a tensile strength of at least 2 MPa, or a tensile strength of at least 3 MPa, or a tensile strength of at least 4 MPa, or a tensile strength of at least 5 MPa, or a tensile strength of at least 6 MPa, or a tensile strength of at least 7 MPa.

In certain embodiments, the electrolyte has a thickness in a range of 1 to 1000 micrometers, or in a range of 1 to 500 micrometers, or in a range of 1 to 100 micrometers.

An electrolyte of the present disclosure can be incorporated into an electrochemical device including any of the cathode and anode materials described above. In certain embodiments, the device is a zinc ion battery, and the cathode comprises a zinc host material selected from the group consisting of (i) metal oxides, metal sulfides, metal phosphates, and metal selenides wherein the metal is one or more of manganese, vanadium, zinc, lithium, cobalt, iron, molybdenum, titanium, niobium, bismuth and tungsten, (ii) poly(benzoquinonyl sulfide), (iii) lead titanate, (iv) Prussian blue compounds, (v) electrically conductive polymers, and (vi) mixtures thereof. In one embodiment, the cathode comprises poly(benzoquinonyl sulfide), and the anode comprises a material selected from metallic zinc and zinc alloys. In one embodiment, the zinc ion battery can include a zinc-deposition morphology of zinc platelets on the anode. In one embodiment, the zinc ion battery includes a zinc-deposition morphology of hexagonal zinc platelets with an orientation parallel to a surface of the anode. In one embodiment, the platelets have a size greater than 500 nanometers. In one embodiment, the platelets have a size greater than 1 micrometer.

In one embodiment, the zinc ion battery has an areal capacity greater than 2 mAh cm⁻² at a current density of 5 mA cm⁻². In one embodiment, the zinc ion battery has a Coulombic efficiency greater than 98% over 400 cycles at a C-rate of 2C. In one embodiment, the zinc ion battery has a Coulombic efficiency greater than 99% over 400 cycles at a C-rate of 2C. In one embodiment, the zinc ion battery has a capacity retention of greater than 60% over 400 cycles at a C-rate of 2C. In one embodiment, the zinc ion battery has a capacity retention of greater than 70% over 400 cycles at a C-rate of 2C.

In one embodiment, the device is a zinc air battery, and the cathode comprises porous carbon.

An electrolyte of the present disclosure can be incorporated into a composite electrode comprising a zinc host material. The electrode can be a cathode or an anode. In one embodiment, the electrode includes 2 wt. % to 20 wt. % of the electrolyte based on a total weight of the electrode. The zinc host material can be selected from the group consisting of (i) metal oxides, metal sulfides, metal phosphates, and metal selenides wherein the metal is one or more of manganese, vanadium, zinc, lithium, cobalt, iron, molybdenum, titanium, niobium, bismuth and tungsten, (ii) poly(benzoquinonyl sulfide), (iii) lead titanate, (iv) Prussian blue compounds, (v) electrically conductive polymers, and (vi) mixtures thereof. In one embodiment of the electrode, the electrolyte has a zinc ion conductivity of greater than 70 mS cm⁻¹ at room temperature. In one embodiment of the electrode, the electrolyte has nanopores. In one embodiment of the electrode, the electrolyte has a BET surface area of at least 16 m² g⁻¹. In one embodiment of the electrode, the electrolyte has a tensile strength of at least 5 MPa. In one embodiment of the electrode, the zinc cations are coordinated with amino groups and hydroxyl groups of the chitosan molecular chains. In one embodiment of the electrode, the plurality of chitosan molecular chains are crosslinked by contacting the plurality of chitosan molecular chains with the zinc cations in a hydroxide solution.

The electrolyte of the present disclosure can be formed according to the following non-limiting example methods. The method can comprise: (a) casting a flowable composition including chitosan on a support to form a chitosan membrane on the support; (b) contacting the chitosan membrane with a solution including zinc cations to form a chitosan-Zn membrane; and (c) separating the chitosan-Zn membrane from the support to form an electrolyte comprising a plurality of chitosan molecular chains crosslinked with zinc cations. Step (b) can further comprise applying a pressure to the chitosan-Zn membrane after contacting the chitosan membrane with the solution, wherein the pressure is above atmospheric pressure. The flowable composition can include 1 wt. % to 10 wt. % chitosan based on a total weight of the flowable composition. In one embodiment of the method, step (b) comprises immersing the chitosan membrane on the support in a bath containing the solution, wherein the solution is an alkaline solution. In one embodiment of the method, the solution is a hydroxide solution. In one embodiment of the method, the solution is a Zn²⁺-saturated NaOH solution. In one embodiment of the method, step (b) further comprises washing the chitosan-Zn membrane with water.

In one embodiment of the method, step (a) comprises transporting the support from a roll of the support to a zone where the flowable composition including chitosan is cast on the support. In one embodiment of the method, step (c) comprises collecting the electrolyte on a roll after separating the electrolyte from the support. In one embodiment of the method, step (b) comprises applying a pressure of 1 MPa or greater, or applying a pressure of in a range of 1 MPa to 10 MPa.

In one embodiment of the method, step (b) comprises applying the pressure such that the electrolyte has pores below micrometer scale. In one embodiment of the method, step (b) comprises applying the pressure such that the electrolyte has no pores above micrometer scale. In one embodiment of the method, step (c) comprises applying the pressure such that the electrolyte has a BET surface area of at least 16 m² g⁻¹. In one embodiment of the method, step (b) comprises applying the pressure such that the electrolyte has a tensile strength of at least 2 MPa, or a tensile strength of at least 3 MPa, or a tensile strength of at least 4 MPa, or a tensile strength of at least 5 MPa, or a tensile strength of at least 6 MPa, or a tensile strength of at least 7 MPa.

### Example

The following Example has been presented in order to further illustrate the aspects of the present disclosure and is not intended to limit the present disclosure in any way. The statements provided in the Example are presented without being bound by theory.

### 1. Overview of the Example

Rechargeable aqueous Zn-metal battery is promising for grid energy storage needs, but its application is limited by issues such as Zn dendrite formation. In this Example, we demonstrate a Zn-coordinated chitosan (chitosan-Zn) electrolyte for high-performance Zn-metal batteries. The chitosan-Zn electrolyte exhibits high mechanical strength, Zn²⁺ conductivity, and water bonding capability, which enable a desirable Zn-deposition morphology of parallel hexagonal Zn platelets. Using the chitosan-Zn electrolyte, the Zn anode shows exceptional cycling stability and rate performance, with a high Coulombic efficiency of 99.7% and >1,000 cycles at 50 mA cm⁻². The full batteries show excellent high-rate performance (up to 20C, 40 mA cm⁻²) and long-term cycling stability (>400 cycles at 2C). Furthermore, the chitosan-Zn electrolyte is non-flammable and biodegradable, making the Zn-metal battery appealing in terms of safety and sustainability, demonstrating the promise of sustainable biomaterials for green and efficient energy-storage systems.

### 2. Introduction to the Example

To reduce carbon emissions and realize carbon neutrality, it is essential to develop sustainable rechargeable batteries for the storage of renewable energy [Ref.1,2]. Aqueous rechargeable batteries, such as Zn-metal batteries, which use a Zn-metal anode and water-based electrolytes, are attractive candidates to fulfill these energy storage demands due to their inherent safety, fast charging/discharging capability, environmental friendliness, wide material availability, and low cost [Ref. 3,4]. However, rechargeable Zn-metal batteries have yet to be commercialized, largely because of problems associated with the Zn-metal anode, including undesired Zn dendrite formation, corrosion, and hydrogen generation during the Zn plating/stripping process [Ref. 5,6], all of which can cause low cycling reversibility and ultimately battery failure.

These issues mainly stem from the unregulated Zn-deposition morphology at high current densities as well as the high free-water content in conventional aqueous electrolytes, which reacts with the Zn-metal during electrochemical cycling [Ref. 7-10]. The aqueous electrolyte induces surface passivated reactions on Zn surface, which leads to inhomogeneous Zn deposition that causes possible dendrite penetration through the separator and low cycling reversibility [Ref. 11-13]. To address these challenges, extensive efforts have been devoted to modifying the electrolyte, including the use of high-salt-concentration “water-in-salt” electrolytes [Ref. 14-16], various additives to aqueous electrolytes (such as ethylene glycol as a water blocker) [Ref. 17,18], or organic electrolytes [Ref. 19,20]. However, these strategies sacrifice the intrinsic high conductivity of aqueous electrolytes and/or compromise the safety of the Zn-metal battery [Ref. 21]. There are reports of hydrogel electrolytes that show promise at inhibiting Zn dendrites, as the nanochannels and polar groups of the hydrogel can control the free-water content and enhance the uniformity of the current distribution [Ref. 9, 22-24]. However, current hydrogel electrolytes do not meet the high mechanical strength, high rate capability, and long-term cycling stability needed for high-performance Zn-metal batteries [Ref. 1, 25].

In this Example, we demonstrate a biopolymeric chitosan-Zn gel electrolyte for high-rate and long-life Zn-metal batteries that features a strong combination of high ionic conductivity, mechanical strength, and sustainability while also enabling a desirable deposition morphology of parallel hexagonal Zn platelets (rather than Zn dendrites) on the anode surface. Chitosan is an eco-friendly and biodegradable biopolymer derived from naturally abundant chitin, which is widely available in crustacean shells [Ref. 26]. The chitosan molecules contain rich hydroxyl and amine groups that can form hydrogen bonds with water to reduce the content of free water in the chitosan-Zn gel electrolyte. We fabricate this gel electrolyte by first coordinating the chitosan biopolymer with Zn²⁺ in a Zn²⁺-saturated NaOH solution and then squeezing out excess water by compressing the material, forming a densified chitosan-Zn membrane (FIG. 1A, Panel A). Prior to densification, the porous chitosan-Zn contains a high amount of water, resulting in unregulated Zn deposition that readily forms mossy dendrites (FIG. 1A, Panel B). However, by tailoring the water content through densification, which confines the aqueous electrolyte to nanoscale pores, we can achieve a high Zn²⁺ ionic conductivity (72 mS cm⁻¹) in addition to the electrodeposition of Zn as parallel platelets on the Zn anode at high current densities (5-50 mA cm⁻²). This morphology helps to prevent interfacial side reactions and dendrite penetration (FIG. 1A Panel C). As a result, the Zn anode with the densified chitosan-Zn electrolyte displays excellent reversibility with a high Coulombic efficiency of 99.7% and long cycle life of >1,000 cycles at 50 mA cm⁻². Using the chitosan-Zn electrolyte and a poly(benzoquinonyl sulfide) (PBQS) organic cathode with a high mass loading (10 mg cm⁻²), we demonstrate Zn-metal full cells with a high areal capacity (2.3 mAh cm⁻²) and good cycling stability (2 C, 4 mA cm⁻² for >400 cycles). Furthermore, the chitosan-Zn electrolyte is non-flammable and biodegradable, allowing for the fabrication of safe and eco-friendly Zn-metal batteries when paired with the biodegradable organic cathode and recyclable Zn-metal anode. These advantages of the chitosan-Zn electrolyte not only enable high-rate and durable Zn-metal batteries but also suggest the potential of natural biopolymers for sustainable and green energy-storage applications.

### 3. Results and Discussion

### 3.1 Material Fabrication and Characterization

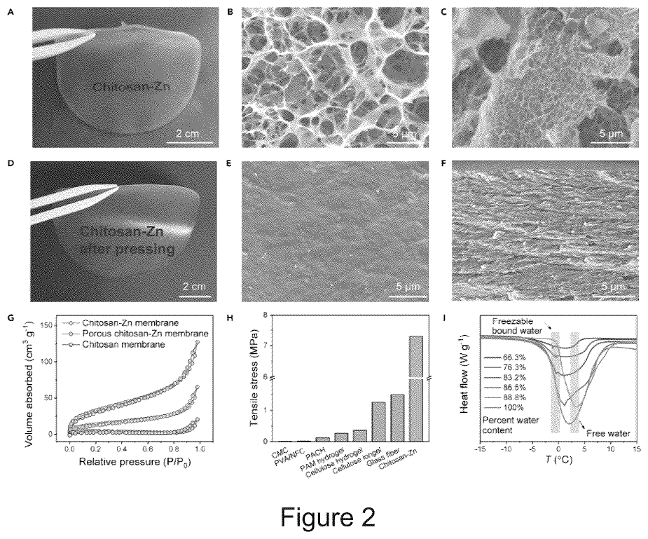

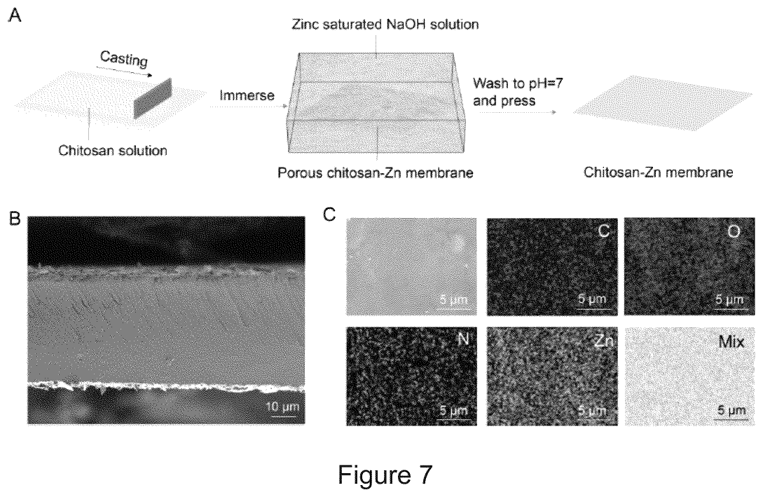

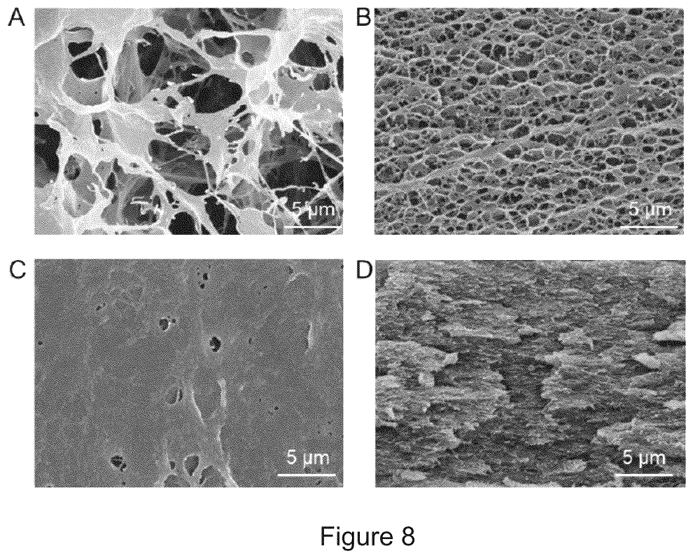

We prepared the chitosan-Zn membrane using a two-step process (FIG. 7 Panel A; see experimental procedures below for more details). First, we cast a chitosan solution (4 wt. % chitosan in 4 wt. % acetic acid aqueous solution) on a polyethylene terephthalate (PET) support and then immediately immersed it into a Zn²⁺-saturated NaOH solution (0.6 wt. % Zn²⁺) to obtain the chitosan-Zn membrane. Next, we rinsed the membrane with water until the pH of the washing solution was 7, followed by mechanically pressing at a pressure of ˜5 MPa to produce the final densified chitosan-Zn membrane. The chitosan-Zn membrane without pressing (FIG. 2 Panel A) shows a hierarchically porous structure, with large pores of up to 5 mm in diameter (FIG. 2 Panel B and FIG. 2 Panel C). These pores are generated as a result of phase separation of the polymeric chitosan that is induced by the solvent-nonsolvent exchange process [Ref. 27]. Compressing the porous chitosan-Zn membrane produces a flexible chitosan-Zn membrane (FIG. 2 Panel D). Top-view and cross-sectional scanning electron microscopy (SEM) images of the pressed chitosan-Zn membrane reveal no obvious pores at the micrometer scale, showing that the membrane is densified compared with the porous starting material (FIG. 2 Panels E-F and FIG. 7 Panel B). Additionally, energy-dispersive X-ray spectroscopy (EDS) elemental mapping of the chitosan-Zn membrane (FIG. 7 Panel C) confirms that the Zn²⁺ ions are homogeneously dispersed throughout the chitosan. As a control sample, a pure chitosan membrane was prepared by a similar procedure, only replacing the immersion solution with just 20 wt. % NaOH (i.e., no Zn²⁺ ions), producing a structure similar to the chitosan-Zn membrane (FIG. 8).

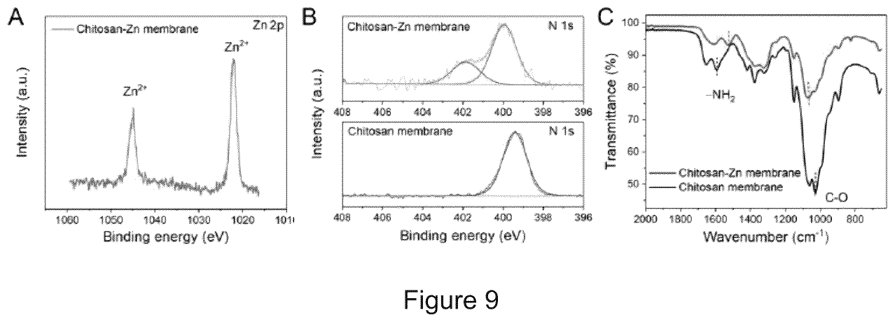

We performed X-ray photoelectron spectroscopy (XPS) and Fourier-transform infrared (FTIR) spectroscopy to investigate the chemical valences and bonding states in the densified chitosan-Zn and chitosan membranes. The Zn 2p peaks in the XPS spectrum of the chitosan-Zn membrane clearly show the presence of Zn²⁺ (FIG. 9 Panel A). In the N 1s XPS spectrum, both samples display a peak at 400 eV due to the —NH₂ groups of chitosan. However, the chitosan-Zn membrane also features a peak at 401.8 eV in the N 1s spectrum, which is attributed to the —N . . . Zn²⁺ coordination bond [Ref. 28], indicating that the —NH₂ groups are partially coordinated with Zn²⁺ ions (FIG. 9 Panel B). Additionally, the FTIR adsorption of the —NH₂ bending vibration shifts from 1,590 cm⁻¹ in chitosan to 1,523 cm⁻¹ in the chitosan-Zn membrane, further suggesting the coordination between —NH₂ and Zn²⁺ (FIG. 9 Panel C). Meanwhile, the broad adsorption of the C—O bond in the chitosan-Zn sample shifts from 1,027 to 1,065 cm⁻¹, indicating that the —OH groups on chitosan are coordinated with Zn²⁺ as well (FIG. 9 Panel C). These results suggest the Zn²⁺ ions coordinate with both the —NH₂ and —OH groups of the chitosan in the chitosan-Zn membrane, which could cross-link the polymeric chitosan chains.

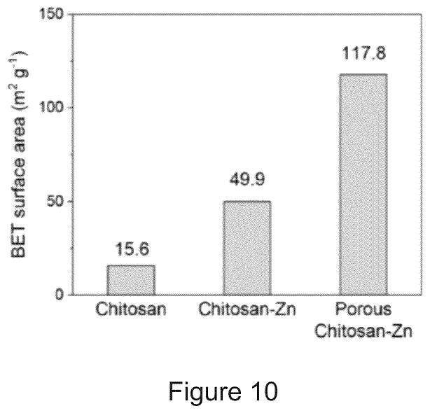

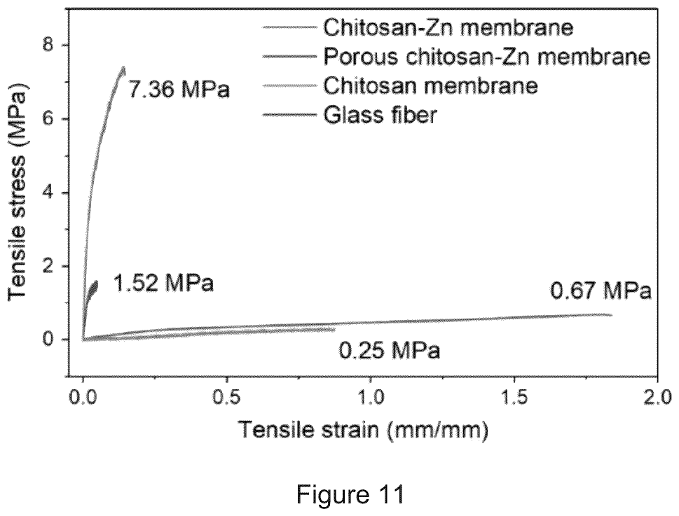

We measured the N₂ adsorption/desorption isotherms of the densified chitosan, porous chitosan-Zn, and densified chitosan-Zn membranes to compare their surface area (FIG. 2 Panel G and FIG. 10). The porous chitosan-Zn membrane has the largest Brunauer-Emmett-Teller (BET) surface area (117.8 m² g⁻¹) and pore volume, mainly featuring macropores (FIG. 2 Panel B). In contrast, pressing the chitosan-Zn membrane eliminates most macroscale pores (FIG. 2 Panel E), resulting in a moderate BET surface area (17.8 m² g⁻¹). Additionally, the densified chitosan-Zn membrane features a higher BET surface area compared with the pure densified chitosan membrane, mainly due to the presence of micropores and mesopores, which are formed due to the coordination between the chitosan and Zn²⁺. The densification and Zn-coordination process also increases the mechanical strength of the densified chitosan-Zn membrane (FIG. 11), which features a high tensile strength of 7.4 MPa—much higher than that of other Zn²⁺ electrolytes (e.g., cellulose hydrogel, [Ref. 23], CMC membrane [Ref. 29]) as well as the glass-fiber separator that is commonly used in Zn-metal batteries (FIG. 2 Panel H). Such an improvement in mechanical strength should be beneficial for suppressing dendrite penetration through the chitosan-Zn electrolyte.

While water plays an important role in the ion conduction of electrolytes, excess water also induces side reactions and dendrite formation on the Zn-metal anode [Ref. 9,10]. Thus, we evaluated the water-absorption ability and water content of the chitosan-Zn membrane. Different water contents (66.3-88.8 wt. %) can be achieved by soaking chitosan-Zn membranes in water or through evaporation. We hypothesized that due to the hydrophilic hydroxyl and amine groups of chitosan, the chitosan-Zn would be able to confine water molecules via hydrogen bonding, thus reducing the ratio of free water in the membrane. Indeed, differential scanning calorimetry (DSC) showed that the chitosan-Zn membranes with different water contents featured both bound water and free water (FIG. 2 Panel I). The water bonding capability of the chitosan-Zn membrane may help reduce side reactions of the aqueous electrolyte with the Zn-metal anode, which could improve the battery performance.

### 3.2 Conductivity and Zn Electrodeposition Behavior

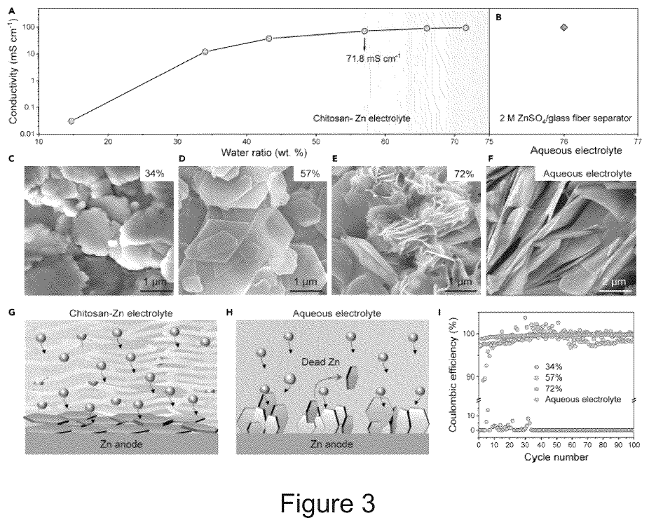

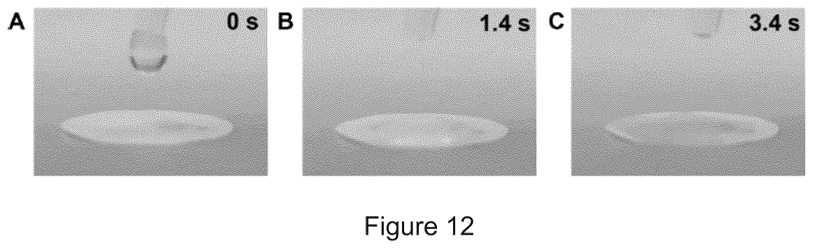

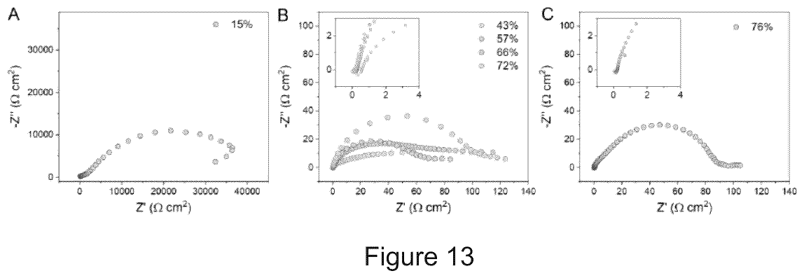

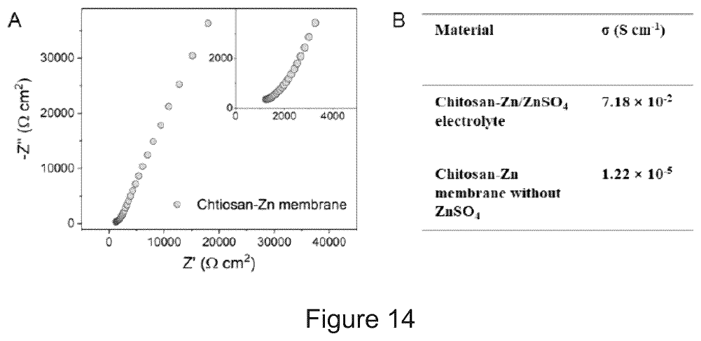

We found the chitosan-Zn membrane serves as an excellent Zn²⁺ electrolyte with a high Zn²⁺ ionic conductivity and advantageous Zn plating behavior. The chitosan-Zn electrolytes were obtained by immersing the porous chitosan-Zn membranes in 2 M ZnSO₄ aqueous solution, followed by the densifying procedure. The excellent wettability of the chitosan-Zn membrane toward ZnSO₄ aqueous solution (FIG. 12) facilitates the sufficient adsorption of ZnSO₄ into the porous chitosan-Zn membrane and the successful fabrication of high performance of chitosan-Zn electrolyte. By evaporation or through soaking in water, chitosan-Zn electrolytes with different water contents (15%-72%) were prepared. We tested the ionic conductivities of chitosan-Zn electrolytes with different water contents (FIG. 3 Panel A and FIG. 13) and compared them with the 2M ZnSO₄ aqueous electrolyte with a glass-fiber separator (FIG. 3 Panel B) by electrochemical impedance spectroscopy (EIS). The chitosan-Zn electrolyte with a low water content of 15% showed a low conductivity of 0.03 mS cm⁻¹, which would prevent high-rate Zn cycling. By increasing the water content to 57%, a high conductivity of 71.8 mS cm⁻¹ in chitosan-Zn electrolyte was achieved, close to that of the aqueous Zn²⁺-electrolyte solution and a standout among previously reported Zn²⁺ electrolytes (see Table S1). Further increasing the water content to over 57% does not significantly enhance the ionic conductivity. If the porous chitosan-Zn membrane is not immersed in ZnSO₄ aqueous solution, a much lower conductivity of 1.22×10⁻⁵ S cm⁻¹ is received (FIG. 14), which demonstrates that Zn²⁺ from ZnSO₄ in chitosan-Zn electrolyte is mobile and responsible for the Zn²⁺ transport. In contrast, coordinated Zn²⁺ in chitosan-Zn membrane is almost not mobile but provides strong mechanical strength and porous nanostructure.

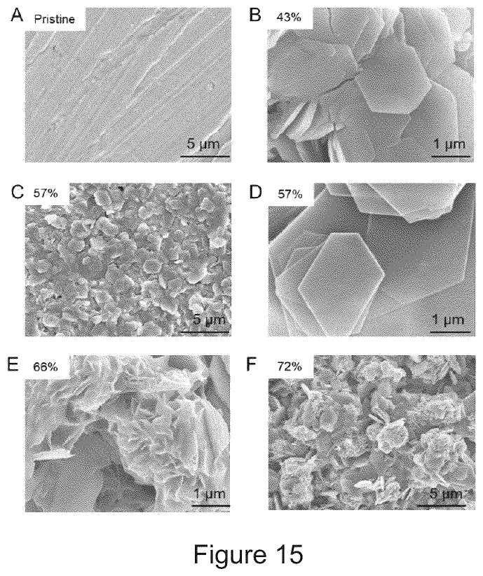

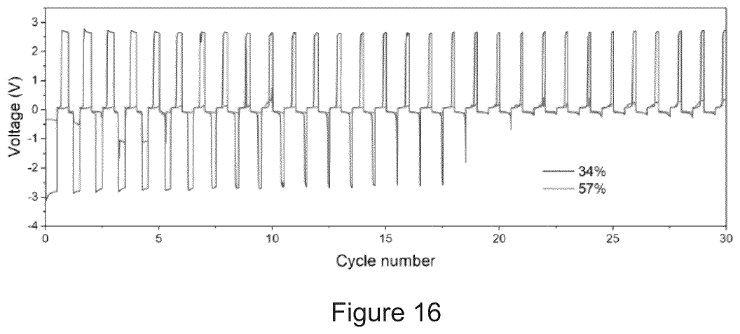

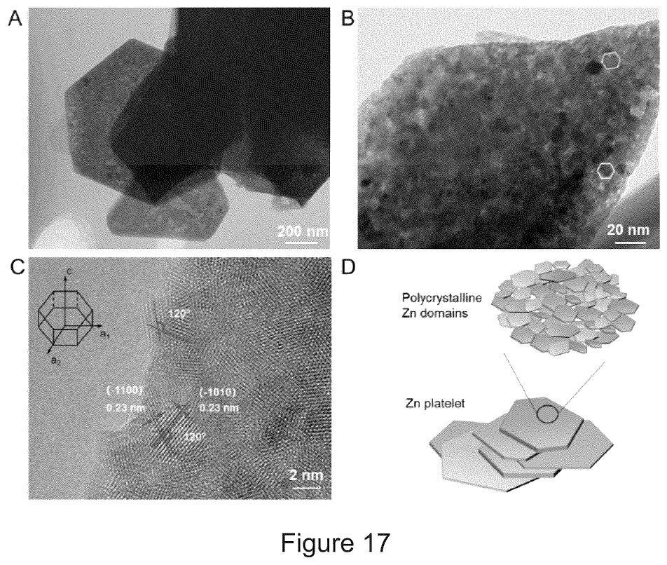

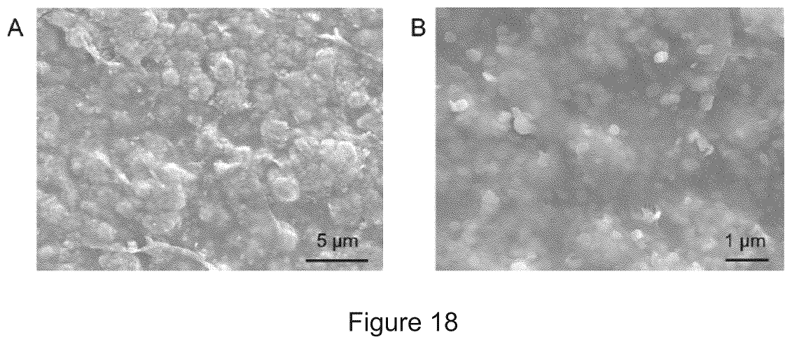

We applied a galvanostatic plating/stripping method to investigate the Zn plating behavior in Zn∥Zn cells using chitosan-Zn electrolytes with different water contents (34%, 57%, and 72%) and compared them with the pure aqueous electrolyte of 2 M ZnSO₄. After cycling at 20 mA cm⁻² and 4 mAh cm⁻² for 50 cycles, we used SEM to observe the Zn plating morphology on the Zn anodes (FIG. 3 Panel C to FIG. 3 Panel F, and FIG. 15 Panel A). The chitosan-Zn electrolyte with 34% water content had a large plating overpotential compared with the 57%-water-content sample (FIG. 16) and can only deposit limited Zn (FIG. 3 Panel C). When using the chitosan-Zn electrolyte with 43% and 57% water contents, the plated Zn forms hexagonal Zn platelets with an orientation parallel to the Zn electrode surface (FIG. 15 Panels B-D and FIG. 3 Panel D). Transmission electron microscopy (TEM) images of the plating Zn using the 57%-water-content electrolyte show that the hexagonal Zn platelets are composed of small hexagonal Zn domains, with (0002) planes in the in-plane direction and (−1010) planes in the through-plane direction (FIG. 17). We also found that the size of the Zn hexagonal platelets grows with the cycle number, from ˜200 nm (20 cycles; FIG. 18) to >1 mm (50 cycles; FIG. 3 Panel D), which reduces the surface area of the Zn anode and suppresses the interfacial side reactions. While the 66%- and 72%-water-content chitosan-Zn electrolytes and aqueous electrolyte (2 M ZnSO₄) provide slightly higher conductivities (90, 94, and 99 mS cm⁻¹, respectively), the higher amount of free water in these electrolytes leads to unfavorable Zn plating morphologies. The high-water-content chitosan-Zn electrolytes display a mossy Zn plating morphology (FIG. 3 Panel E, FIG. 15 Panel E, and FIG. 15 Panel F), and using the aqueous electrolyte with a glass-fiber separator results in Zn platelets perpendicular to the Zn electrode surface (FIG. 3 Panel F). The mossy Zn dendrites could cause increased interfacial side reactions with the electrolyte, and their perpendicularly oriented morphologies could lead to dendritic short circuiting. Therefore, the chitosan-Zn electrolyte with a water content of just 57% is more advantageous, as it displays both high conductivity and a superior Zn plating morphology.

The deposition of hexagonal Zn platelet is because the (0002) plane of Zn has a lower surface energy (0.33 Jm⁻²) than other planes (e.g., 0.53 J m⁻² of the (−1010) plane), which causes the preferential crystal growth of Zn in the (0002) plane, forming hexagonal platelets [Ref. 34]. The chitosan-Zn electrolyte enables fast and uniform Zn²⁺ conduction while also limiting ion flux perpendicular to Zn anode surface, forming parallel Zn platelets compactly stacked on the anode (FIG. 3 Panel G). Such a deposition morphology can reduce the electrolyte-Zn interface area and interfacial side reactions, preventing the formation of inactive dead Zn and also reducing the possibility of dendrite penetration through the separator, all of which improved the Zn anode cycling reversibility and lifespan. In contrast, while the aqueous electrolyte also has a high Zn²⁺ ionic conductivity, the Zn²⁺ supply is ubiquitous and from all directions. Thus, in the liquid electrolyte, Zn²⁺ ions diffuse via the shortest path, and the plated Zn-metal tends to form platelets oriented perpendicular to the anode surface (FIG. 3 Panel H) [Ref. 35,36] which is adverse to the anode reversibility and stability.

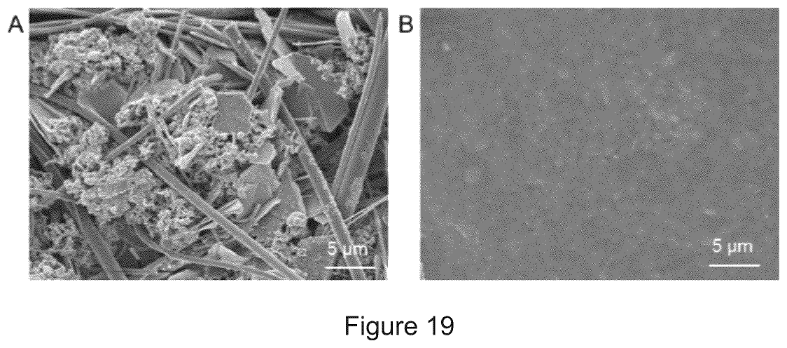

The Zn cycling reversibility of the chitosan-Zn electrolyte is evidenced by the Coulombic efficiency of the Zn-metal anode, which we investigated by cycling Zn∥chitosan-Zn∥Cu cells at 5 mA cm⁻² with a capacity of 5 mAh cm⁻² (FIG. 3 Panel I). Using the chitosan-Zn electrolyte with 57% water content, the cell shows a Coulombic efficiency of ˜99.5% after 100 cycles, indicating excellent Zn plating/stripping reversibility. In contrast, the Coulombic efficiency of the Zn anode with the aqueous ZnSO₄ electrolyte is not stable, fluctuating in the range of 96.8%-99.6%, due to inhomogeneous Zn deposition (FIG. 19 Panel A). The chitosan-Zn electrolyte with a lower water content of 34% showed a low Coulombic efficiency of <2% and the chitosan-Zn electrolyte with more water (72%) showed a Coulombic efficiency of <99% in the first ten cycles but then significantly fluctuated over subsequent cycles, showing a poor reversibility (FIG. 3 Panel I). We attribute the high and stable Coulombic efficiency of the 57%-water-content chitosan-Zn electrolyte to the material's superior Zn plating morphology, in which the parallel Zn platelets deposited on the Zn anode help suppress dendrite formation and penetration through the chitosan-Zn membrane (FIG. 19 Panel B), allowing for stable and reversible Zn plating/stripping.

### 3.3 Electrochemical Performance

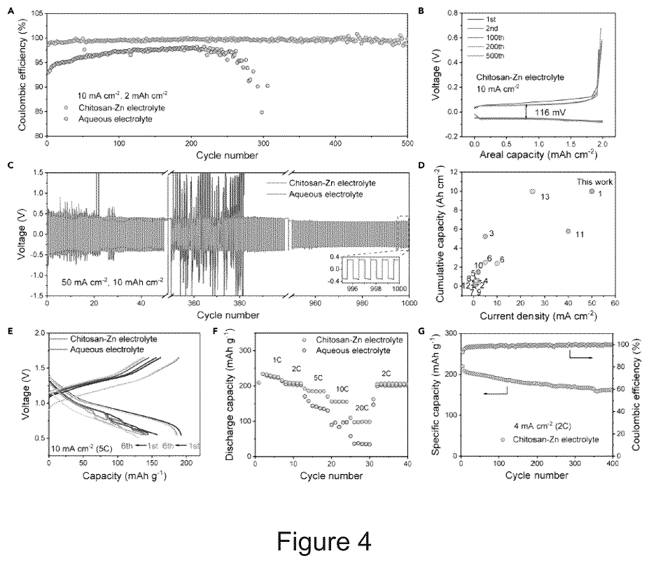

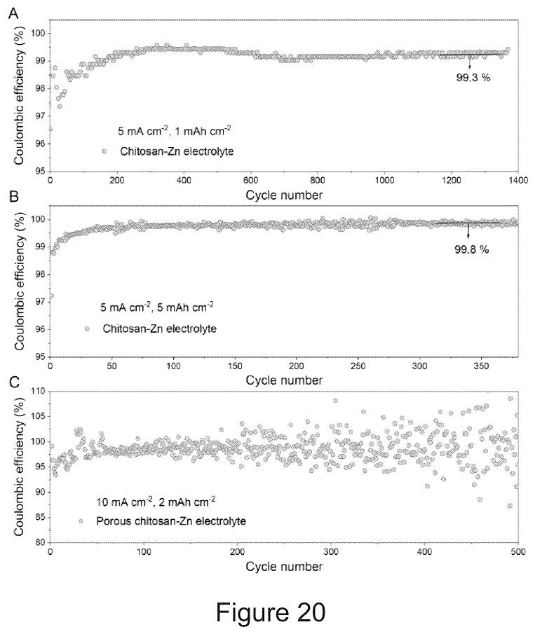

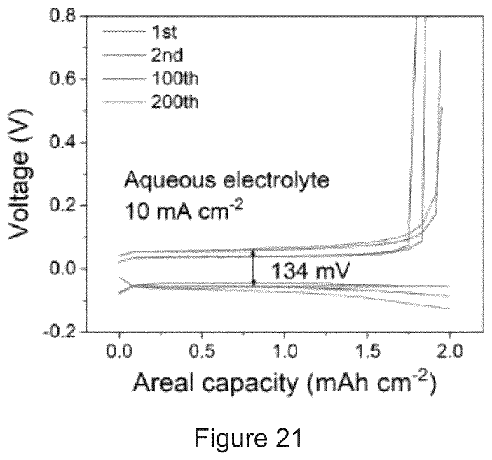

We further tested the Coulombic efficiency at high-current-density and high-capacity conditions in Zn∥Cu cells to evaluate the performance of the Zn anode made with the 57%-water-content chitosan-Zn electrolyte (which was used in all following experiments unless otherwise indicated). The Zn∥Cu cells show a high Coulombic efficiency of 99.3% for 1,300 cycles at 5 mA cm⁻² with a capacity of 1 mAh cm⁻² and 99.8% at 5 mA cm⁻² with a capacity of 5 mAh cm⁻² (FIG. 20 Panel A and FIG. 20 Panel B). We further cycled the cells at 10 mA cm⁻² with a capacity of 2 mAh cm⁻², which showed a high Coulombic efficiency of 99.7% for 500 cycles (FIG. 4 Panel A). In contrast, using the aqueous ZnSO₄ electrolyte or the porous chitosan-Zn electrolyte (without the densifying step and therefore containing more water), the Coulombic efficiencies are low and not stable (FIG. 4 Panel A and FIG. 20 Panel C). In addition, the Zn plating/stripping voltage profile of the cell made with the chitosan-Zn electrolyte (57% water content) shows a smaller and more stable voltage hysteresis of 116 mV (FIG. 4 Panel B) than that of aqueous electrolyte (134 mV; FIG. 21).

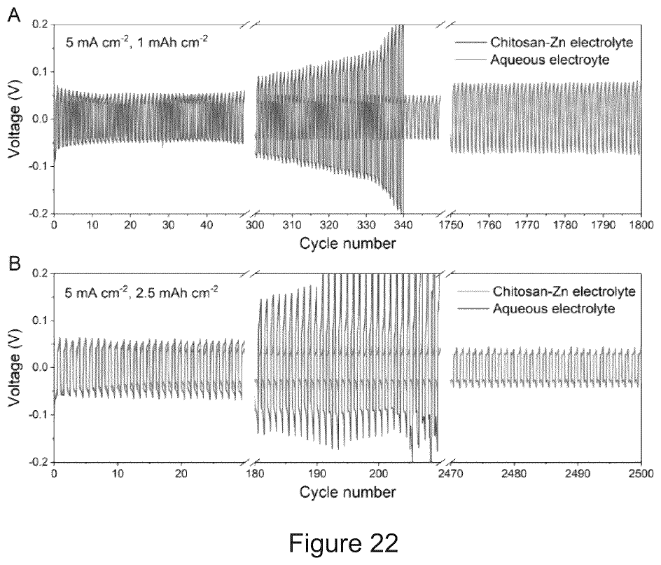

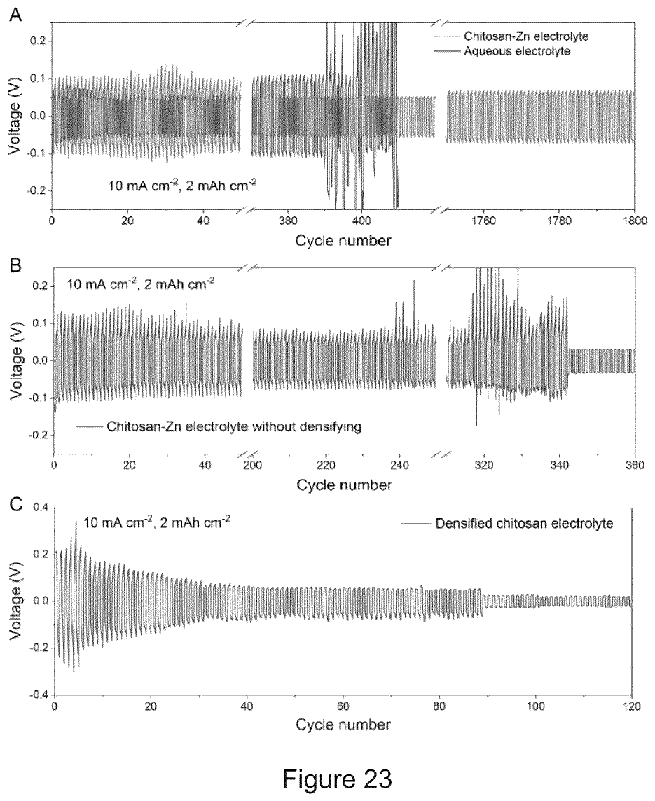

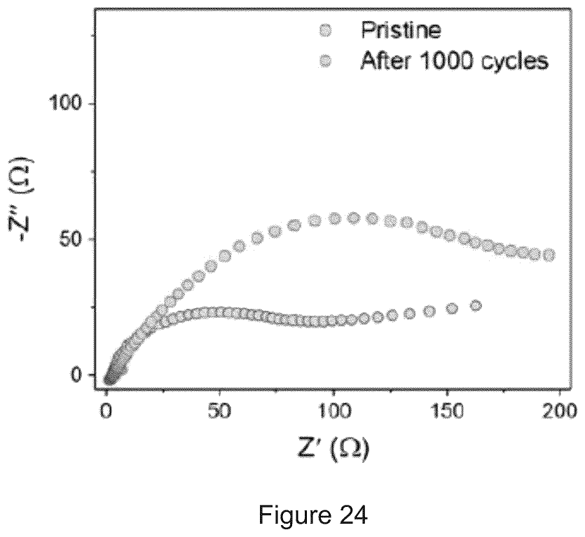

With the chitosan-Zn electrolyte, we achieved excellent cycling performance and long lifespan in symmetric Zn-metal batteries at high current densities (up to 50 mA cm⁻²). The symmetric Zn batteries using the chitosan-Zn electrolyte can stably cycled for up to ˜2,500 cycles at 5 mA cm⁻² with capacities of 1 and 2.5 mAh cm⁻² (FIG. 22 Panel A and FIG. 22 Panel B). At 10 mA cm⁻², the cell shows a polarization voltage of 100 mV and remains almost constant throughout the 1,800 cycles (red line in FIG. 23 Panel A). In contrast, using the aqueous ZnSO₄ electrolyte, the porous chitosan-Zn electrolyte, and the densified chitosan electrolyte (without Zn²⁺ cross-linking), the cells soon failed because of either irreversible voltage increase (black line in FIG. 23 Panel A) or short circuiting (FIG. 23 Panel B and FIG. 23 Panel C). Furthermore, after 1,000 cycles, the symmetric Zn battery using the chitosan-Zn electrolyte showed only a slight increase of the interface resistance compared with the fresh cell (FIG. 24) without short circuiting, indicating the durability of the Zn anode interface using the chitosan-Zn electrolyte. Even at a high current density of 50 mA cm⁻², the chitosan-Zn electrolyte can still enable stable cycling of the Zn-metal anode with a capacity of 10 mAh cm⁻² and depth of discharge of 17.1% for 1,000 cycles without significant voltage fluctuation (FIG. 4 Panel C). In contrast, using the aqueous electrolyte, the cell suffered from irreversible voltage increase and eventually failed at the 350th cycle (FIG. 4 Panel C).

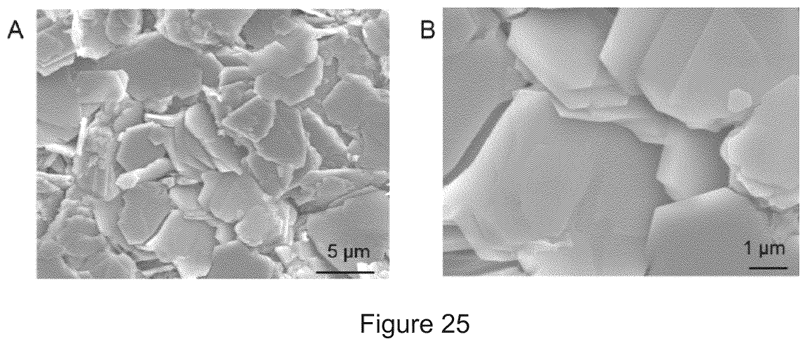

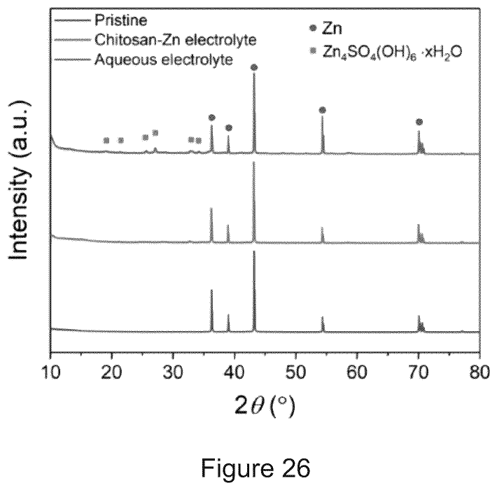

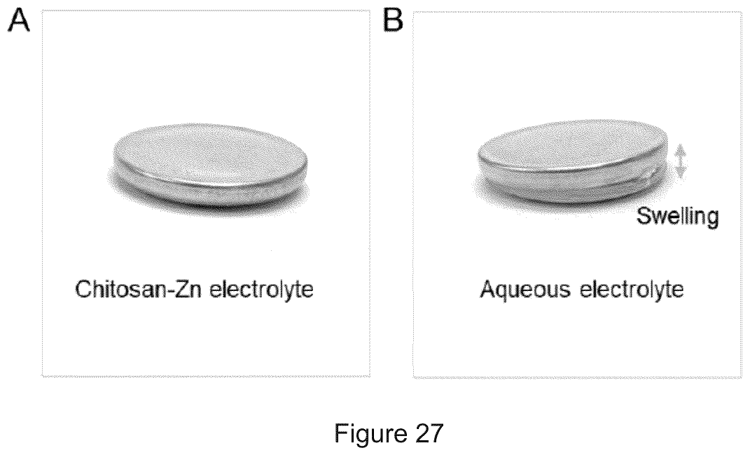

We examined the Zn anode surface after 1,000 cycles at 10 mA cm⁻² with the chitosan-Zn electrolyte and found that the Zn maintained platelet-like morphology (FIG. 25). Such durable deposition behavior increases the Zn deposits density and reduces the surface area, suppressing interfacial side reactions for high reversibility. X-ray diffraction (XRD) patterns of the cycled Zn anodes using the chitosan-Zn and aqueous electrolytes demonstrate that Zn₄SO₄(OH)₆·xH₂O, which is the side product commonly found on Zn-metal anodes cycled using aqueous-based electrolytes, [Ref. 37] is effectively suppressed with the chitosan-Zn electrolyte (FIG. 26). The chitosan-Zn electrolyte also suppresses H₂ production, which is suggested by the reduced swelling of the coin cell cases after cycling at 50 mA cm⁻² compared with the aqueous Zn-metal battery (FIG. 27), mitigating the long-term issue of the hydrogen evolution in aqueous Zn batteries [Ref. 10].

With the chitosan-Zn electrolyte, we can cycle the Zn symmetric cell at 50 mA cm⁻² with a cumulative plating capacity of 10 Ah cm⁻² (FIG. 4 Panel C), outperforming all previously reported symmetric cells with Zn²⁺-conducting electrolytes (including hydrogel electrolytes and Zn salt with different additives; see Table S2), demonstrating the excellent potential of the chitosan-Zn electrolyte for Zn-metal anodes. Thus, the symmetric cell built with the chitosan-Zn electrolyte shows collective advantages on current density and cumulative plated Zn capacity over other reported electrolytes (FIG. 4 Panel D).

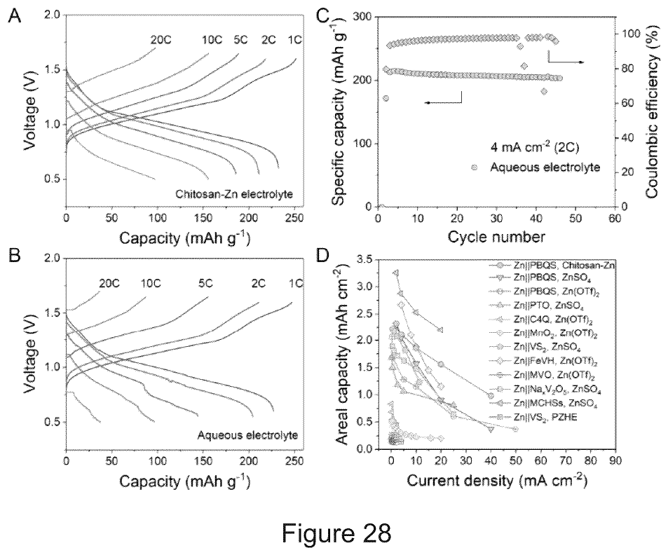

To evaluate the performance of the chitosan-Zn electrolyte in full cells, we used an organic cathode material (PBQS) to couple with the Zn-metal anode. PBQS is a promising organic electrode material for aqueous Zn batteries due to its low cost, abundant resources, high reversible capacity, and good cycling stability [Ref. 38,39], as well as its biodegradable and environmentally friendly properties as one member of quinone family [Ref. 4]. Pairing the PBQS cathode (with a high PBQS mass loading of 10 mg cm⁻²) with the Zn-metal anode and the chitosan-Zn electrolyte, the Zn full cell shows a higher discharge/charge capacity (˜190 mAh g⁻¹) and lower overpotential at rate capacity of 5C (1C=200 mA g⁻¹) than the cell using aqueous electrolyte (FIG. 4 Panel E). The Zn-metal battery using the chitosan-Zn electrolyte exhibits outstanding rate performance, delivering discharge capacities of 232, 211, 186, and 156 mAh g⁻¹ at 1, 2, 5, and 10C, respectively (for the 2nd cycle at each rate, FIG. 4 Panel F and FIG. 28 Panel A). Even at a high rate of 20C, a discharge capacity of 98 mAh g⁻¹ is achieved with a good reversibility, demonstrating the high-rate capability of the full battery using the chitosan-Zn electrolyte. When the rate changes from 20 to 2C, the reversible capacity recovers to 208 mAh g⁻¹, demonstrating its excellent reversibility (FIG. 4 Panel F). In addition, the cell using the chitosan-Zn electrolyte has a good capacity retention of 71% and a high Coulombic efficiency of close to 100% over 400 cycles (FIG. 4 Panel G). The capacity decay is mainly due to the PBQS volume change during cycling and the induced mechanical fracture [Ref. 40]. In contrast, the control cell using the aqueous electrolyte, which has a similar Zn²⁺ conductivity (99 mS cm⁻¹) to the chitosan-Zn electrolyte, only shows 157, 90, and 37 mAh g⁻¹ at 5, 10, and 20C, respectively (FIG. 4 Panel F and FIG. 28 Panel B). The Zn battery in the aqueous electrolyte can also deliver a discharge capacity of 206 mAh g⁻¹ at 2C for 46 cycles but short circuited after the 46th cycle, likely due to Zn dendrite penetration (FIG. 28 Panel C). The battery using the chitosan-Zn electrolyte also achieves much better rate capacity than most Zn-metal batteries with different electrolytes [Ref. 39,41-50], which we compare by their areal capacity-current density curves (FIG. 28 Panel D). Such improvements in battery performance regarding capacity, rate performance, and cycling life are attributed to the preferable Zn plating morphology and suppressed side reactions, enabled by the chitosan-Zn electrolyte.

### 3.4 Non-Flammability and Biodegradability

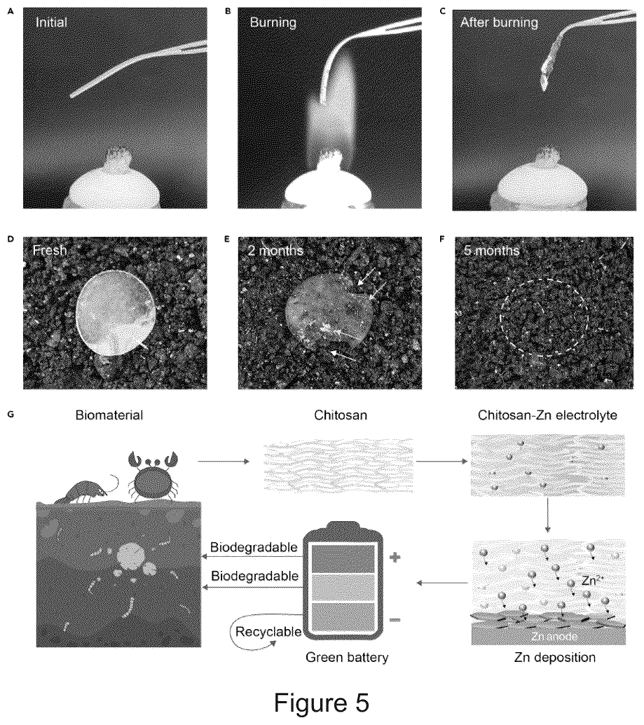

Aside from the high-rate and high-capacity performance, we also demonstrated the safety and sustainability of the cell using the chitosan-Zn electrolyte. As a gel electrolyte filled with aqueous solution, the chitosan-Zn electrolyte is not flammable and only shrinks and becomes soft when placed in a flame (FIG. 5 Panels A-C). We ascribe the non-flammability of the chitosan-Zn electrolyte to its non-flammable components, including the chitosan polymer [Ref. 59] and aqueous electrolyte of ZnSO₄, which ensures the high safety of the Zn-metal batteries. Due to the utilization of biopolymeric chitosan, the chitosan-Zn electrolyte is also biodegradable, which we verified by burying the membrane in soil (FIG. 5 Panels D-F). After burying the fresh chitosan-Zn electrolyte (FIG. 5 Panel D) in soil for 2 months (FIG. 5 Panel E), the chitosan-Zn electrolyte became moldy (indicated by the yellow arrows in FIG. 5 Panel E) and started to degrade (indicated by the white arrows in FIG. 5 Panel E). It totally degraded after 5 months (FIG. 5 Panel F), indicating that the chitosan-Zn electrolyte is biodegradable. The chitosan-Zn electrolyte derived from natural biomaterial (shrimp, crab, and so on) not only displays excellent performance in batteries but also releases the constitutes back to the environment in a natural way. Other components of the Zn-metal battery are either also biodegradable (PQBS cathode), environmentally friendly (aqueous solution), or recyclable (Zn-metal) (FIG. 5 Panel G). Thus, the biodegradable chitosan-Zn electrolyte allows for the possibility of developing green batteries, as we schematically illustrate in FIG. 5 Panel G. Moreover, due to the natural abundance of chitosan and the facile fabrication process of the chitosan-Zn electrolyte, the chitosan-Zn material is expected to have a low manufacturing cost of ˜$4.2 m⁻² or $46.5 kg⁻¹ (see Table S3), comparable to commercial separators (e.g., Celgard) [Ref. 60]. Such a high-rate and high-capacity performance, as well as the high safety, biodegradability, and low cost, render chitosan-based Zn-metal batteries promising for practical large-scale energy-storage applications.

### 4. Conclusions

In conclusion, we have developed a sustainable Zn-coordinated chitosan electrolyte and demonstrate its high performance for use in Zn-metal batteries. The chitosan-Zn membrane was fabricated using a facile two-step method of Zn²⁺-coordination of chitosan, followed by mechanical pressing, resulting in a dense structure. The chitosan-Zn membrane displays a high mechanical strength and water bonding capability, which enables a tunable Zn²⁺ conductivity and controllable Zn electrodeposition morphology. With controlled water content of 57%, the chitosan-Zn electrolyte exhibits a high ionic conductivity of 72 mS cm⁻¹ and enables a desirable parallel Zn platelet deposition morphology. As a result, the chitosan-Zn electrolyte can enable cycle at 50 mA cm⁻² for >1,000 cycles with excellent reversibility and high Coulombic efficiency (99.7%). The Zn-metal full cells fabricated using the chitosan-Zn electrolyte show a high-rate performance (10-20C) and long lifespan (>400 cycles at 2C) with an areal capacity of 2.3 mAh cm⁻² (cathode loading of 10 mg cm⁻²), better than most of the reported Zn-metal batteries. Owing to its excellent electrochemical performance, low cost, high safety, biodegradability, and facile fabrication method, the chitosan-Zn electrolyte and its design strategy paves a way for developing high-performance and sustainable biopolymer-based electrolytes for green energy-storage and -conversion devices.

### 5. Experimental Procedures

### 5.1 Materials

Chitosan powder (>75% deacetylated) was purchased from Millipore Sigma. Zinc foil (100 mm in thickness) was purchased from MTI. Sodium hydroxide and zinc sulfate were purchased from Millipore Sigma and used directly without any treatment.

### 5.2 Preparation of the Chitosan-Zn Membrane

Chitosan powder (1 g) was first dissolved in 4 wt. % acetic acid aqueous solution (200 mL) by stirring overnight at room temperature to produce a 0.5 wt. % chitosan solution. A filtration process was used to remove the undissolved impurities. The obtained transparent chitosan solution was further concentrated through evaporation to obtain a viscous ˜4 wt. % chitosan solution. This chitosan solution was then drop cast on a Petri dish or cast on a PET film with a doctor blade with a solution weight of ˜0.16 g cm⁻². The resulting chitosan wet film was then immediately immersed in a Zn²⁺-saturated NaOH solution (0.6 wt. % Zn²⁺ measured by inductively coupled plasma mass spectrometry [ICP-MS]) for 4 days, which was prepared by immersing excess Zn foil in 20 wt. % NaOH solution for 1 week. A porous chitosan-Zn membrane is formed by the solvent-nonsolvent exchange process, in which the acidic aqueous solution is the solvent and the NaOH aqueous solution is the nonsolvent. The resulting porous chitosan-Zn membrane was washed with excess water. A pressure of ˜5 MPa was applied to densify the porous chitosan-Zn membrane to obtain the densified chitosan-Zn membrane. The dry porous and densified chitosan-Zn membranes were freeze dried for material characterization.

### 5.3 Preparation of the Chitosan-Zn Electrolyte

The porous chitosan-Zn membrane was immersed in 2 M ZnSO₄ aqueous solution overnight and then pressed at 5 MPa to densify the membrane. The resulting chitosan-Zn electrolyte was then obtained after wiping excess ZnSO₄ solution off the surface of the densified membrane with a mass of m₀. The water content in this electrolyte is 57% based on the ratio of m₁ and m₀, where m₁ is the mass of chitosan-Zn electrolyte after removing water completely in vacuum oven at 100° C. The chitosan-Zn electrolyte samples with different water contents were prepared by evaporating the densified membrane (m₀) in air or soaking the densified membrane in 2 M ZnSO₄ solution, until membranes were obtained with masses of 0.5, 0.75, 1.25, and 1.5 m₀. The calculated water content in these chitosan-Zn electrolytes was 34%, 43%, 66%, and 72%, respectively.

### 5.4 Battery Assembly and Electrochemical Tests

Zn symmetric cells were assembled using Zn foils for both the cathode and anode and either the chitosan-Zn electrolyte (which also served as the separator) or aqueous electrolyte (100 mL 2M ZnSO₄) with a glass-fiber separator. The asymmetric Cu∥Zn cells were assembled using Cu foil and Zn foil as the cathode and anode, respectively. All cells were assembled in an ambient environment using CR2032 coin cells and were tested at room temperature. The galvanostatic plating/stripping profiles were measured at different areal capacities and different current densities on a NEWARE battery-testing system. The Zn plating/stripping Coulombic efficiencies were probed at different current densities with a charge-cutoff voltage of 1 V. EIS data were measured using a Biologic VMP3 electrochemical workstation at an amplitude of 10 mV at an open-circuit voltage.

### 5.5 Assembly of the Zn-PBQS Battery and Electrochemical Tests

Poly(benzoquinonyl sulfide) (PBQS) was synthesized following a method reported in the literature [Ref. 46]. To prepare composite electrodes, PBQS, Ketjen black (KB) carbon, and polytetrafluoroethylene (PTFE) were mixed at a mass ratio of 7:2:1 with 2 mL ethanol as the dispersant. The freestanding electrodes were cut and pressed into stainless-steel meshes (1 cm², 100×100 mesh) and dried at 80° C. under vacuum for 12 hours before cell assembly. The areal loading of the active material was ˜10 mg cm⁻².

The electrochemical performances of the composite electrodes were evaluated in a split cell by using zinc foil as the anode and chitosan-Zn electrolyte (150 mm) or 80 mL of 2 M ZnSO₄ aqueous electrolyte with a glass-fiber separator (Whatman, 150 mm). Electrochemical characterization was performed with a potentiostat (VMP3, Biologic). The cells were tested under different charge/discharge rates of 1 to 20C, where 1C equals a current density of 200 mA g⁻¹. All electrochemical tests were run at room temperature.

### 5.6 Material Characterization

The morphologies of the samples were studied by SEM at 10 kV on a Hitachi SU-70 with EDS analysis at 15 kV. XPS was conducted on a Thermo ESCALAB 250. The C1s peak at 284.8 eV was used as a reference to calibrate the binding energy values of other peaks. FTIR was performed with a Thermo Nicolet NEXUS 670 FTIR with an attenuated total reflectance (ATR) accessory.

XRD was performed on a Bruker D8 Advance powder diffractometer with Cu radiation (scan rate of 2° min⁻¹). N₂ adsorption/desorption isotherms were measured on a Micromeritics ASAP 2020 Porosimeter. Specific surface area and pore size were determined by the BET and Barrett-Joyner-Halenda (BJH) methods, respectively. Tensile stress-strain curves were conducted on a tabletop model testing system (Instron, Norwood, MA, USA) with a running speed of 0.1 mm min-. DSC was performed on a TA Instruments DSC Q100. The samples are first cooled to ˜30° C. then heated to 20° C. to obtain a melting curve with a cooling/heating rate of 5° C. min⁻¹. ICP was conducted on a PerkinElmer NexION 300D ICP-MS, where ⁶³Cu standard solutions were used to construct a calibration curve.

TABLE S1
Ionic conductivity comparison of reported Zn²⁺ electrolytes.

| No | Material | Conductivity (mS cm⁻¹) | Ref. |
|---|---|---|---|
| 1 | Chitosan-Zn electrolyte | 71.8 | This work |
| 2 | Chitosan-biocellulosics | 86.7 | ¹³ |
| 3 | Cellulose-based hydrogel | 7409 | ¹⁴ |
| 4 | PVA/nanocellulose hydrogel | 18.1 | ¹⁵ |
| 5 | Gelatin-based solid-state | 16 | ¹⁶ |
| | electrolyte | | |
| 6 | Polyacrylamide hydrogel/ | 25 | ¹⁷ |
| | 2M ZnSO₄ + 4M LiCl/H₂O | | |
| 7 | Zn(OTf)₂/7 Triethyl | 6.48 | ¹⁸ |
| | phosphate:3 H₂O | | |
| 8 | 2M Zn(BF₄)₂/[EMIM]BF₄ | 16.9 | ¹⁹ |
| | ionic liquid | | |
| 9 | 2M ZnSO₄/H₂O + EG | 7.5 | ²⁰ |
| | (50 vol % EG) | | |
| 10 | Water-in-deep eutectic | 1.85 | ²¹ |
| | solvent | | |
| 11 | 2M ZnSO₄/H₂O | 53 | ²⁰ |

TABLE S2
Performance comparison of galvanostatic Zn plating/striping
between different electrolytes in Zn||Zn cells.

| | | | Current | Areal | | Polarization | |
|---|---|---|---|---|---|---|---|
| | | | density | Capacity | | voltage | |
| No | Anode | Material | (mA cm⁻²) | (mAh cm⁻²) | Cycles | (mV) | Reference |
| 1 | Zn foil | Chitosan-Zn | 5 | 1 | 1800 | 50 | This work |
| | | electrolyte | | | | | |
| 2 | Zn foil | Chitosan-Zn | 10 | 2 | 1800 | 50 | |
| | | electrolyte | | | | | |
| 3 | Zn foil | Chitosan-Zn | 50 | 10 | 1000 | 374 | |
| | | electrolyte | | | | | |
| 4 | Zn foil | 2M ZnSO₄ | 50 | 10 | 350 | 370 | |
| 5 | Zn foil | Polyacrylamide | 1 | 1 | 200 | 80 | ¹⁷ |
| | | hydrogel/2M | | | | | |
| | | ZnSO₄ + | | | | | |
| | | 4M LiCl/H₂O | | | | | |
| 6 | 3D Zn | Chitosan- | 25 | 3.33 | 3000 | <200 | ¹³ |
| | | biocelllulosics | | | | | |
| 7 | ZrO₂- | 2M ZnSO₄ | 5 | 1 | 5250 | 32 | ²² |
| | coated Zn | | | | | | |
| 8 | Zn foil | ZnCl₂ 2.33 H₂O | 5 | 1 | 2500 | 25 | ²³ |
| 9 | Zn foil | ZnCl₂ 2.33 H₂O | 10 | 1 | 2400 | 75 | ²³ |
| 10 | Zn foil | Zn(OTf)₂/7 Triethyl | 0.5 | 5 | 100 | 50 | ¹⁸ |
| | | phosphate:3 H₂O | | | | | |
| 11 | Zn foil | 2M Zn(BF₄)₂/ | 2 | 1 | 1500 | 75 | ¹⁹ |
| | | [EMIM]BF₄ ionic | | | | | |
| | | liquid | | | | | |
| 12 | Zn foil | 1m Zn(TFSI)₂ + 20m | 0.2 | 0.035 | 500 | 150 | ²⁴ |
| | | LiTFSl/H₂O | | | | | |
| 13 | Zn on | 2M ZnBr₂ + 3M KCl | 40 | 20 | 290 | ~55 | ²⁵ |
| | carbon | | | | | | |
| | felt | | | | | | |
| 14 | Zn foil | 1M ZnSO₄/H₂O + AN | 2 | 2 | 300 | ~80 | ¹⁴ |
| | | (15 vol %) | | | | | |
| 15 | Zn foil | 2M ZnSO₄/H₂O + EG | 1 | 1 | 600 | 50 | ²⁰ |
| | | (50 vol %) | | | | | |
| 16 | Zn foil | Water-in-deep | 0.1 | 0.074 | 1622 | 100 | ²¹ |
| | | eutectic solvent | | | | | |
| 17 | Zn foil | 3M Zn(OTf)₂ + Et₂O | 0.2 | 0.2 | 125 | 30 | ²⁶ |
| | | (2 vol %) | | | | | |

TABLE S3
The fabrication cost of the chitosan-Zn electrolyte.

| | | | Cost | Costₐₗₗ | Costₐₗₗ |
|---|---|---|---|---|---|
| | | | (USD/kg | (USD/kg | (USD/m² |
| | Price | Mass | electro- | electro- | electro- |
| Chemicals | (USD/kg) ^{a} | (kg) | lyte) | lyte) ^{b} | lyte) |
| Chitosan | 59 | 6 | 0.354 | 46.55 | 4.19 |
| NaOH | 0.33 | 100 | 0.033 | | |
| ZnSO₄ | 0.4 | 80 | 0.032 | | |

^{a} Prices are sourced from Alibaba.
^{b} Chitosan-Zn electrolyte with a dry mass of 90 g and a size of 1 m² was produced from 60 g chitosan, 100 g NaOH, and 80 g ZnSO₄.

### REFERENCES

1. Zhang, Y., Chen, Z., Qiu, H., Yang, W., Zhao, Z., Zhao, J., and Cui, G. (2020). Pursuit of reversible Zn electrochemistry: a time-honored challenge towards low-cost and green energy storage. NPG Asia Mater. 12, 4.
2. Yu, X., and Manthiram, A. (2021). Sustainable battery materials for next-generation electrical energy storage. Adv. Energy Sustain. Res. 2, 2000102.
3. Chao, D., Zhou, W., Xie, F., Ye, C., Li, H., Jaroniec, M., and Qiao, S.-Z. (2020). Roadmap for advanced aqueous batteries: from design of materials to applications. Sci. Adv. 6, 4098.
4. Xu, P., Tan, D. H., and Chen, Z. (2021). Emerging trends in sustainable battery chemistries. Trends Chem. 3, 620-630.
5. Zhang, T., Tang, Y., Guo, S., Cao, X., Pan, A., Fang, G., Zhou, J., and Liang, S. (2020). Fundamentals and perspectives in developing zinc-ion battery electrolytes: a comprehensive review. Energy Environ. Sci. 13, 4625-4665.
6. Blanc, L. E., Kundu, D., and Nazar, L. F. (2020). Scientific challenges for the implementation of Zn-ion batteries. Joule 4, 771-799.
7. Hao, J., Li, X., Zhang, S., Yang, F., Zeng, X., Zhang, S., Bo, G., Wang, C., and Guo, Z. (2020). Designing dendrite-free zinc anodes for advanced aqueous zinc batteries. Adv. Funct. Mater. 30, 2001263.
8. Kang, L., Cui, M., Jiang, F., Gao, Y., Luo, H., Liu, J., Liang, W., and Zhi, C. (2018). Nanoporous CaCO₃ coatings enabled uniform Zn stripping/plating for long-life zinc rechargeable aqueous batteries. Adv. Energy Mater. 8, 1801090.
9. Huang, S., Zhu, J., Tian, J., and Niu, Z. (2019). Recent progress in the electrolytes of aqueous zinc-ion batteries. Chem. Eur. J. 25, 14480-14494.
10. Verma, V., Kumar, S., Manalastas, W., and Srinivasan, M. (2021). Undesired reactions in aqueous rechargeable zinc ion batteries. ACS Energy Lett. 6, 1773-1785.
11. Wan, F., Zhou, X., Lu, Y., Niu, Z., and Chen, J. (2020). Energy storage chemistry in aqueous zinc metal batteries. ACS Energy Lett. 5, 3569-3590.
12. Qiu, H., Du, X., Zhao, J., Wang, Y., Ju, J., Chen, Z., Hu, Z., Yan, D., Zhou, X., and Cui, G. (2019). Zinc anode-compatible in-situ solid electrolyte interphase via cation solvation modulation. Nat. Commun. 10, 5374.
13. Zhang, Y., Yang, G., Lehmann, M. L., Wu, C., Zhao, L., Saito, T., Liang, Y., Nanda, J., and Yao, Y. (2021). Separator effect on zinc electrodeposition behavior and its implication for zinc battery lifetime. Nano Lett. 21, 10446-10452.
14. Yang, H., Chang, Z., Qiao, Y., Deng, H., Mu, X., He, P., and Zhou, H. (2020). Constructing a Super-saturated electrolyte front surface for stable rechargeable aqueous zinc batteries. Angew. Chem. Int. Ed. Engl. 59, 9377-9381.
15. Wang, F., Borodin, O., Gao, T., Fan, X., Sun, W., Han, F., Faraone, A., Dura, J. A., Xu, K., and Wang, C. (2018). Highly reversible zinc metal anode for aqueous batteries. Nat. Mater. 17, 543-549.
16. Chen, C., Matsumoto, K., Kubota, K., Hagiwara, R., and Xu, Q. (2019). A room-temperature molten hydrate electrolyte for rechargeable zinc-air batteries. Adv. Energy Mater. 9, 1970086.
17. Naveed, A., Yang, H., Yang, J., Nuli, Y., and Wang, J. (2019). Highly reversible and rechargeable safe Zn batteries based on a triethyl phosphate electrolyte. Angew. Chem. Int. Ed. Engl. 58, 2760-2764.
18. Wang, N., Yang, Y., Qiu, X., Dong, X., Wang, Y., and Xia, Y. (2020). Stabilized rechargeable aqueous zinc batteries using ethylene glycol as water blocker. ChemSusChem 13, 5556-5564.
19. Li, H., Han, C., Huang, Y., Huang, Y., Zhu, M., Pei, Z., Xue, Q., Wang, Z., Liu, Z., Tang, Z., et al. (2018). An extremely safe and wearable solid state zinc ion battery based on a hierarchical structured polymer electrolyte. Energy Environ. Sci. 11, 941-951.
20. Han, D., Cui, C., Zhang, K., Wang, Z., Gao, J., Guo, Y., Zhang, Z., Wu, S., Yin, L., Weng, Z., et al. (2021). A non-flammable hydrous organic electrolyte for sustainable zinc batteries. Nat. Sustain. 5, 205-213.
21. Cao, Z., Zhuang, P., Zhang, X., Ye, M., Shen, J., and Ajayan, P. M. (2020). Strategies for dendrite-free anode in aqueous rechargeable zinc ion batteries. Adv. Energy Mater. 10, 2001599.
22. Wang, D., Li, H., Liu, Z., Tang, Z., Liang, G., Mo, F., Yang, Q., Ma, L., and Zhi, C. (2018). A nanofibrillated cellulose/polyacrylamide electrolyte-based flexible and sewable high performance Zn—MnO2 battery with superior shear resistance. Small 14, 1803978.
23. Yang, L., Song, L., Feng, Y., Cao, M., Zhang, P., Zhang, X.-F., and Yao, J. (2020). Zinc ion trapping in a cellulose hydrogel as a solid electrolyte for a safe and flexible supercapacitor. J. Mater. Chem. 8, 12314-12318.
24. Lizundia, E., and Kundu, D. (2021). Advances in natural biopolymer-based electrolytes and separators for battery applications. Adv. Funct. Mater. 31, 2005646.
25. Tang, B., Shan, L., Liang, S., and Zhou, J. (2019). Issues and opportunities facing aqueous zinc ion batteries. Energy Environ. Sci. 12, 3288-3304.
26. Peter, S., Lyczko, N., Gopakumar, D., Maria, H. J., Nzihou, A., and Thomas, S. (2020). Chitin and chitosan based composites for energy and environmental applications: a review. Waste Biomass Valorization 12, 4777-4804.
27. Yoo, S., Kim, J.-H., Shin, M., Park, H., Kim, J.-H., Lee, S.-Y., and Park, S. (2015). Hierarchical multiscale hyperporous block copolymer membranes via tunable dual-phase separation. Sci. Adv. 1, e1500101.
28. Ma, C., Li, F., Wang, C., He, M., Shen, C., Sand, W., and Liu, Y. (2018). Tuning the adsorption behaviour of b-structure chitosan by metal binding. Environ. Chem. 15, 267-277.
29. Zhu, Y. S., Xiao, S. Y., Li, M. X., Chang, Z., Wang, F. X., Gao, J., and Wu, Y. P. (2015). Natural macromolecule based carboxymethyl cellulose as a gel polymer electrolyte with adjustable porosity for lithium ion batteries. J. Power Sources 288, 368-375.
30. Chen, M., Chen, J., Zhou, W., Xu, J., and Wong, C.-P. (2019). High-performance flexible and self-healable quasi-solid-state zinc-ion hybrid supercapacitor based on borax-crosslinked polyvinyl alcohol/nanocellulose hydrogel electrolyte. J. Mater. Chem. 7, 26524-26532.
31. Dai, L., Arcelus, O., Sun, L., Wang, H., Carrasco, J., Zhang, H., Zhang, W., and Tang, J. (2019). Embedded 3D Li+ channels in a water-in-salt electrolyte to develop flexible supercapacitors and lithium-ion batteries. J. Mater. Chem. 7, 24800-24806.
32. Li, H., Liu, Z., Liang, G., Huang, Y., Huang, Y., Zhu, M., Pei, Z., Xue, Q., Tang, Z., Wang, Y., et al. (2018). Waterproof and tailorable elastic rechargeable yarn zinc ion batteries by a crosslinked polyacrylamide electrolyte. ACS Nano 12, 3140-3148.
33. Rana, H. H., Park, J. H., Gund, G. S., and Park, H. S. (2020). Highly conducting, extremely durable, phosphorylated cellulose-based ionogels for renewable flexible supercapacitors. Energy Storage Mater. 25, 70-75.
34. Zheng, J., and Archer, L. A. (2021). Controlling electrochemical growth of metallic zinc electrodes: toward affordable rechargeable energy storage systems. Sci. Adv. 7, eabe0219.
35. Hagopian, A., Doublet, M.-L., and Filhol, J.-S. (2020). Thermodynamic origin of dendrite growth in metal anode batteries. Energy Environ. Sci. 13, 5186-5197.
36. Yao, Y., Wang, Z., Li, Z., and Lu, Y.-C. (2021). A dendrite-free Tin anode for high-energy aqueous redox flow batteries. Adv. Mater. 33, 2008095.
37. Yang, Q., Li, Q., Liu, Z., Wang, D., Guo, Y., Li, X., Tang, Y., Li, H., Dong, B., and Zhi, C. (2020). Dendrites in Zn-based batteries. Adv. Mater. 32, 2001854.
38. Liang, Y., Jing, Y., Gheytani, S., Lee, K.-Y., Liu, P., Facchetti, A., and Yao, Y. (2017). Universal quinone electrodes for long cycle life aqueous rechargeable batteries. Nat. Mater. 16, 841-848.
39. Zhao, Q., Huang, W., Luo, Z., Liu, L., Lu, Y., Li, Y., Li, L., Hu, J., Ma, H., and Chen, J. (2018). High-capacity aqueous zinc batteries using sustainable quinone electrodes. Sci. Adv. 4, 1761.
40. Zhang, Y., Zhao, L., Liang, Y., Wang, X., and Yao, Y. (2022). Effect of electrolyte anions on the cycle life of a polymer electrode in aqueous batteries. eScience 2, 110-115.
41. Dawut, G., Lu, Y., Miao, L., and Chen, J. (2018). High-performance rechargeable aqueous Zn-ion batteries with a poly(benzoquinonyl sulfide) cathode. Inorg. Chem. Front. 5, 1391-1396.
42. Zhang, N., Cheng, F., Liu, J., Wang, L., Long, X., Liu, X., Li, F., and Chen, J. (2017). Rechargeable aqueous zinc-manganese dioxide batteries with high energy and power densities. Nat. Commun. 8, 405.
43. Guo, Z., Ma, Y., Dong, X., Huang, J., Wang, Y., and Xia, Y. (2018). An environmentally friendly and flexible aqueous zinc battery using an organic cathode. Angew. Chem. Int. Ed. Engl. 57, 11737-11741.
44. Xiong, T., Yu, Z. G., Wu, H., Du, Y., Xie, Q., Chen, J., Zhang, Y., Pennycook, S. J., Lee, W. S. V., and Xue, J. (2019). Defect engineering of oxygen-deficient manganese oxide to achieve high-performing aqueous zinc ion battery. Adv. Energy Mater. 9, 1803815.
45. Jiao, T., Yang, Q., Wu, S., Wang, Z., Chen, D., Shen, D., Liu, B., Cheng, J., Li, H., Ma, L., et al. (2019). Binder-free hierarchical VS2 electrodes for high-performance aqueous Zn ion batteries towards commercial level mass loading. J. Mater. Chem. 7, 16330-16338.
46. Song, Z., Qian, Y., Zhang, T., Otani, M., and Zhou, H. (2015). Poly(benzoquinonyl sulfide) as a high-energy organic cathode for rechargeable Li and Na batteries. Adv. Sci. 2, 1500124.
47. Tang, F., Zhou, W., Chen, M., Chen, J., and Xu, J. (2019). Flexible freestanding paper electrodes based on reduced graphene oxide/d-NaₓV₂O₅$·nH₂O nanocomposite for high performance aqueous zinc-ion batteries. Electrochim. Acta. 328, 135137.
48. Ma, H., Tian, X., Wang, T., Tang, K., Liu, Z., Hou, S., Jin, H., and Cao, G. (2021). Tailoring pore structures of 3D printed cellular high-loading cathodes for advanced rechargeable zinc-ion batteries. Small 17, 2100746.
49. Liu, P., Liu, W., Huang, Y., Li, P., Yan, J., and Liu, K. (2020). Mesoporous hollow carbon spheres boosted, integrated high performance aqueous Zn-Ion energy storage. Energy Storage Mater. 25, 858-865.
50. Leng, K., Li, G., Guo, J., Zhang, X., Wang, A., Liu, X., and Luo, J. (2020). A safe polyzwitterionic hydrogel electrolyte for long life quasi-solid state zinc metal batteries. Adv. Funct. Mater. 30, 2001317.
51. Zhu, M., Wang, X., Tang, H., Wang, J., Hao, Q., Liu, L., Li, Y., Zhang, K., and Schmidt, O. G. (2020). Antifreezing hydrogel with high zinc reversibility for flexible and durable aqueous batteries by cooperative hydrated cations. Adv. Funct. Mater. 30, 1907218.
52. Liang, P., Yi, J., Liu, X., Wu, K., Wang, Z., Cui, J., Liu, Y., Wang, Y., Xia, Y., and Zhang, J. (2020). Highly reversible Zn anode enabled by controllable formation of nucleation sites for Zn-based batteries. Adv. Funct. Mater. 30, 1908528.
53. Hou, Z., Tan, H., Gao, Y., Li, M., Lu, Z., and Zhang, B. (2020). Tailoring desolvation kinetics enables stable zinc metal anodes. J. Mater. Chem. 8, 19367-19374.
54. Xu, W., Zhao, K., Huo, W., Wang, Y., Yao, G., Gu, X., Cheng, H., Mai, L., Hu, C., and Wang, X. (2019). Diethyl ether as self-healing electrolyte additive enabled long-life rechargeable aqueous zinc ion batteries. Nano Energy 62, 275-281.
55. Ma, L., Chen, S., Li, N., Liu, Z., Tang, Z., Zapien, J. A., Chen, S., Fan, J., and Zhi, C. (2020). Hydrogen-free and dendrite-free all-solid state Zn-ion batteries. Adv. Mater. 32, 1908121.
56. Yin, Y., Wang, S., Zhang, Q., Song, Y., Chang, N., Pan, Y., Zhang, H., and Li, X. (2020). Dendrite-free zinc deposition induced by Tin modified multifunctional 3D host for stable zinc-based flow battery. Adv. Mater. 32, 1906803.
57. Zhao, J., Zhang, J., Yang, W., Chen, B., Zhao, Z., Qiu, H., Dong, S., Zhou, X., Cui, G., and Chen, L. (2019). Water-in-deep eutectic solvent” electrolytes enable zinc metal anodes for rechargeable aqueous batteries. Nano Energy 57, 625-634.
58. Shinde, S. S., Jung, J. Y., Wagh, N. K., Lee, C. H., Kim, D.-H., Kim, S.-H., Lee, S. U., and Lee, J.-H. (2021). Ampere-hour-scale zinc-air pouch cells. Nat. Energy 6, 592-604.
59. Xiao, Y., Zheng, Y., Wang, X., Chen, Z., and Xu, Z. (2014). Preparation of a chitosan-based flame-retardant synergist and its application in flame-retardant polypropylene. J. Appl. Polym. Sci. 131, 40845.
60. Schmuch, R., Wagner, R., Horpel, G., Placke, T., and Winter, M. (2018). Performance and cost of materials for lithium-based rechargeable automotive batteries. Nat. Energy 3, 267-278.
S1. Yang, Q., Li, Q., Liu, Z., Wang, D., Guo, Y., Li, X., Tang, Y., Li, H., Dong, B., and Zhi, C. (2020). Dendrites in Zn-based batteries. Adv. Mater. 32, 2001854.
S2. Dawut, G., Lu, Y., Miao, L., and Chen, J. (2018). High-performance rechargeable aqueous Zn-ion batteries with a poly(benzoquinonyl sulfide) cathode. Inorg. Chem. Front. 5, 1391-1396.
S3. Zhang, N., Cheng, F., Liu, J., Wang, L., Long, X., Liu, X., Li, F., and Chen, J. (2017). Rechargeable aqueous zinc-manganese dioxide batteries with high energy and power densities. Nat. Comm. 8, 405.
S4. Guo, Z., Ma, Y., Dong, X., Huang, J., Wang, Y., and Xia, Y. (2018). An environmentally friendly and flexible aqueous zinc battery using an organic cathode. Angew. Chem. Int. Ed. 57, 11737-11741.
S5. Xiong, T., Yu, Z. G., Wu, H., Du, Y., Xie, Q., Chen, J., Zhang, Y.-W., Pennycook, S. J., Lee, W. S. V., and Xue, J. (2019). Defect engineering of oxygen-deficient manganese oxide to achieve high-performing aqueous zinc ion battery. Adv. Energy Mater. 9, 1803815.
S6. Zhao, Q., Huang, W., Luo, Z., Liu, L., Lu, Y., Li, Y., Li, L., Hu, J., Ma, H., and Chen, J. (2018). High-capacity aqueous zinc batteries using sustainable quinone electrodes. Sci. Adv. 4, 1761.
S7. Jiao, T., Yang, Q., Wu, S., Wang, Z., Chen, D., Shen, D., Liu, B., Cheng, J., Li, H., Ma, L., et al. (2019). Binder-free hierarchical VS2 electrodes for high-performance aqueous Zn ion batteries towards commercial level mass loading. J. Mater. Chem. A 7, 16330-16338.
S8. Song, Z., Qian, Y., Zhang, T., Otani, M., and Zhou, H. (2015). Poly(benzoquinonyl sulfide) as a high-energy organic cathode for rechargeable Li and Na batteries. Adv. Sci. 2, 1500124.
S9. Tang, F., Zhou, W., Chen, M., Chen, J., and Xu, J. (2019). Flexible freestanding paper electrodes based on reduced graphene oxide/δ-NaₓV₂O₅·nH₂O nanocomposite for high-performance aqueous zinc-ion batteries. Electrochim. Acta 328, 135137.
S10. Liu, P., Liu, W., Huang, Y., Li, P., Yan, J., and Liu, K. (2020). Mesoporous hollow carbon spheres boosted, integrated high performance aqueous Zn-Ion energy storage. Energy Storage Mater. 25, 858-865.
S11. Ma, H., Tian, X., Wang, T., Tang, K., Liu, Z., Hou, S., Jin, H., and Cao, G. (2021). Tailoring pore structures of 3D printed cellular high-loading cathodes for advanced rechargeable zinc-ion batteries. Small 17, 2100746.
S12. Leng, K., Li, G., Guo, J., Zhang, X., Wang, A., Liu, X., and Luo, J. (2020). A safe polyzwitterionic hydrogel electrolyte for long-life quasi-solid state zinc metal batteries. Adv. Funct. Mater. 30, 2001317.
S13. Shinde, S. S., Jung, J. Y., Wagh, N. K., Lee, C. H., Kim, D.-H., Kim, S.-H., Lee, S. U., and Lee, J.-H. (2021). Ampere-hour-scale zinc-air pouch cells. Nat. Energy 6, 592-604.
S14. Hou, Z., Tan, H., Gao, Y., Li, M., Lu, Z., and Zhang, B. (2020). Tailoring desolvation kinetics enables stable zinc metal anodes. J. Mater. Chem. A 8, 19367-19374.
S15. Chen, M., Chen, J., Zhou, W., Xu, J., and Wong, C.-P. (2019). High-performance flexible and self-healable quasi-solid-state zinc-ion hybrid supercapacitor based on borax-crosslinked polyvinyl alcohol/nanocellulose hydrogel electrolyte. J. Mater. Chem. A 7, 26524-26532.
S16. Han, Q., Chi, X., Liu, Y., Wang, L., Du, Y., Ren, Y., and Liu, Y. (2019). An inorganic salt reinforced Zn²⁺-conducting solid-state electrolyte for ultra-stable Zn metal batteries. J. Mater. Chem. A 7, 22287-22295.
S17. Zhu, M., Wang, X., Tang, H., Wang, J., Hao, Q., Liu, L., Li, Y., Zhang, K., and Schmidt, O. G. (2020). Antifreezing hydrogel with high zinc reversibility for flexible and durable aqueous batteries by cooperative hydrated cations. Adv. Funct. Mater. 30, 1907218.
S18. Naveed, A., Yang, H., Yang, J., Nuli, Y., and Wang, J. (2019). Highly reversible and rechargeable safe Zn batteries based on a triethyl phosphate electrolyte. Angew. Chem. Int. Ed. 58, 2760-2764.
S19. Ma, L., Chen, S., Li, N., Liu, Z., Tang, Z., Zapien, J. A., Chen, S., Fan, J., and Zhi, C. (2020). Hydrogen-free and dendrite-free all-solid-state Zn-ion batteries. Adv. Mater. 32, 1908121.
S20. Wang, N., Yang, Y., Qiu, X., Dong, X., Wang, Y., and Xia, Y. (2020). Stabilized rechargeable aqueous zinc batteries using ethylene glycol as water blocker. ChemSusChem 13, 5556-5564.
S21. Zhao, J., Zhang, J., Yang, W., Chen, B., Zhao, Z., Qiu, H., Dong, S., Zhou, X., Cui, G., and Chen, L. (2019). “Water-in-deep eutectic solvent” electrolytes enable zinc metal anodes for rechargeable aqueous batteries. Nano Energy 57, 625-634.
S22. Liang, P., Yi, J., Liu, X., Wu, K., Wang, Z., Cui, J., Liu, Y., Wang, Y., Xia, Y., and Zhang, J. (2020). Highly reversible Zn anode enabled by controllable formation of nucleation sites for Zn-based batteries. Adv. Funct. Mater. 30, 1908528.
S23. Chen, C.-Y., Matsumoto, K., Kubota, K., Hagiwara, R., and Xu, Q. (2019). A roomtemperature molten hydrate electrolyte for rechargeable zinc-air batteries. Adv. Energy Mater. 9, 1900196.
S24. Wang, F., Borodin, O., Gao, T., Fan, X., Sun, W., Han, F., Faraone, A., Dura, J. A., Xu, K., and Wang, C. (2018). Highly reversible zinc metal anode for aqueous batteries. Nat. Mater. 17, 543-549.
S25. Yin, Y., Wang, S., Zhang, Q., Song, Y., Chang, N., Pan, Y., Zhang, H., and Li, X. (2020). Dendrite-free zinc deposition induced by Tin-modified multifunctional 3D host for stable zinc-based flow battery. Adv. Mater. 32, 1906803.
S26. Xu, W., Zhao, K., Huo, W., Wang, Y., Yao, G., Gu, X., Cheng, H., Mai, L., Hu, C., and Wang, X. (2019). Diethyl ether as self-healing electrolyte additive enabled long-life rechargeable aqueous zinc ion batteries. Nano Energy 62, 275-281.
   The citation of any document is not to be construed as an admission that it is prior art with respect to the present disclosure.

Thus, examples of the present disclosure provide electrolytes that can facilitate transport of ions with wide applications in electrochemical devices, such as batteries. In particular, we have found that a biomaterial-derived chitosan-Zn electrolyte enables favorable Zn-platelet deposition due to its high mechanical strength, high Zn²⁺ conductivity, and water bonding capability. The chitosan-Zn electrolyte not only enables high-rate and long-life performance in zinc metal batteries, but is also biodegradable, appealing for clean and efficient energy storage.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, “in an embodiment”, “in some embodiments”, “in certain embodiments”, or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the present disclosure has been described in considerable detail with reference to certain embodiments, one skilled in the art will appreciate that aspects of the present disclosure can be used in alternative embodiments to those described, which have been presented for purposes of illustration and not of limitation. Therefore, the scope of the appended claims should not be limited to the description of the embodiments contained herein.

What is claimed is:

1. An electrolyte comprising:
a plurality of chitosan molecular chains crosslinked with zinc cations.

2. The electrolyte of claim 1 wherein:
the electrolyte has a zinc ion conductivity of greater than 30 mS cm⁻¹ at room temperature.

3. The electrolyte of claim 1 wherein:
the electrolyte has a water content of 20 wt. % to 75 wt. % based on a total weight of the electrolyte.

4. The electrolyte of claim 1 wherein:
the electrolyte has pores below micrometer scale.

5. The electrolyte of claim 1 wherein:
the electrolyte has nanopores.

6. The electrolyte of claim 1 wherein:
the electrolyte has a BET surface area of at least 16 m² g⁻¹.

7. The electrolyte of claim 1 wherein:
the electrolyte has a tensile strength of at least 2 MPa.

8. The electrolyte of claim 1 wherein:
the zinc cations are coordinated with amino groups and hydroxyl groups of the chitosan molecular chains.

9. The electrolyte of claim 1 wherein:
the electrolyte has a thickness in a range of 1 to 1000 micrometers.

10. The electrolyte of claim 1 wherein:
the plurality of chitosan molecular chains are crosslinked by contacting the plurality of chitosan molecular chains with the zinc cations in an alkaline environment.

11. The electrolyte of claim 1 wherein:
the plurality of chitosan molecular chains are crosslinked by contacting the plurality of chitosan molecular chains with the zinc cations in a hydroxide solution.

12. An electrochemical device comprising:
an anode;
a cathode; and
the electrolyte of claim 1 positioned between the anode and the cathode.

13. The device of claim 12 wherein:
the device is a zinc ion battery, and
the cathode comprises a zinc host material selected from the group consisting of (i) metal oxides, metal sulfides, metal phosphates, and metal selenides wherein the metal is one or more of manganese, vanadium, zinc, lithium, cobalt, iron, molybdenum, titanium, niobium, bismuth and tungsten, (ii) poly(benzoquinonyl sulfide), (iii) lead titanate, (iv) Prussian blue compounds, (v) electrically conductive polymers, and (vi) mixtures thereof.

14. The device of claim 13 wherein:
the anode comprises a material selected from metallic zinc and zinc alloys, and
the zinc ion battery includes a zinc-deposition morphology of zinc platelets on the anode.

15. The device of claim 14 wherein:
the zinc ion battery includes a zinc-deposition morphology of hexagonal zinc platelets with an orientation parallel to a surface of the anode.

16. An electrode comprising:
a zinc host material; and
an electrolyte comprising a plurality of chitosan molecular chains crosslinked with zinc cations.

17. The electrode of claim 16 wherein:
the electrode includes 2 wt. % to 20 wt. % of the electrolyte based on a total weight of the electrode, and
the zinc host material is selected from the group consisting of (i) metal oxides, metal sulfides, metal phosphates, and metal selenides wherein the metal is one or more of manganese, vanadium, zinc, lithium, cobalt, iron, molybdenum, titanium, niobium, bismuth and tungsten, (ii) poly(benzoquinonyl sulfide), (iii) lead titanate, (iv) Prussian blue compounds, (v) electrically conductive polymers, and (vi) mixtures thereof.

18. A method for forming an electrolyte, the method comprising:
(a) casting a flowable composition including chitosan on a support to form a chitosan membrane on the support;
(b) contacting the chitosan membrane with a solution including zinc cations to form a chitosan-Zn membrane; and
(c) separating the chitosan-Zn membrane from the support to form an electrolyte comprising a plurality of chitosan molecular chains crosslinked with zinc cations.

19. The method of claim 18 wherein:
step (b) further comprises applying a pressure to the chitosan-Zn membrane after contacting the chitosan membrane with the solution, the pressure being above atmospheric pressure.

20. The method of claim 19 wherein:
the pressure is 1 MPa or greater, and
the solution is a Zn²⁺-saturated hydroxide solution.
